(19) United States
(12) Patent Application Publication
(10) Pub. No.: US 2006/0136332 A1
(43) Pub. Date: Jun. 22, 2006

(54) System and method for electronic check verification over a network

(76) Inventor: Robert Ziegler, Dallas, TX (US)

Correspondence Address: HOWISON & ARNOTT, L.L.P, P.O. BOX 741715, DALLAS, TX, 75374-1715, US

(21) Appl. No.: 11/241,862

(22) Filed: Oct. 1, 2005

Related U.S. Application Data
(60) Provisional application No. 60/615,484, filed on Oct. 1, 2004.

(51) Int. Cl. G06Q 40/00

(52) U.S. Cl. 705/39

(57) ABSTRACT

A method is disclosed of authenticating a consumer and authorizing a transaction over a network. The method includes first requesting, by a user, performance of a transaction between said user and a merchant, the user and the merchant performing the transaction over a non-secure web page. The user then enters transaction request information into a non-secure general purpose computer, and then enters a PIN into a graphic interface of the non-secure web page on the non-secure general purpose computer. providing, by the non-secure general purpose computer, the transaction request information and a PIN data package, the PIN data package being a digital representation of an impression of the users selection of at least one graphic image representing their PIN to a secure transaction manager via an internet system. The transaction manager then combines at least one of dynamic and corollary data with the PIN data package and securely provides the combination to a hardware security module (HSM). The HSM then distills the PIN data package into a PIN and encrypting the PIN into a PIN Block. Thereafter; the remainder of the transaction is performed.

### CROSS-REFERENCE

This application claims benefit of U.S. Provisional Application Ser. No. 60/615,484, filed Oct. 1, 2004, entitled SYSTEM AND METHOD FOR ELECTRONIC CHECK VERIFICATION OVER A NETWORK.

This application is related to U.S. patent application Ser. No. ______, Attorney docket number Payt-27345, titled METHOD AND SYSTEM OF AUTHENTICATION ON AN OPEN NETWORK, filed Oct. 1, 2005, which is incorporated herein by reference.

### TECHNICAL FIELD OF THE INVENTION

This invention is related to a financial security protocol, and more particularly an electronic check verification protocol and system for use over a network.

### BACKGROUND OF THE INVENTION

Numerous methods and system for providing the exchange of funds over an open network (i.e., Internet) in a manner analogous to a negotiable paper have been implemented. One significant problem in an open network use of an electronic check is the authentication of the negotiable instrument. Various security protocols have evolved, but because the authentications do not typically involve the financial institutions that ultimately tender the monies, they face significant barriers to acceptance by those financial institutions and represent significant risks to the parties.

What is needed, therefore, is a system and method for authenticating negotiable instruments over an open network in a manner that is acceptable to the various financial institutions.

### SUMMARY OF THE INVENTION

The present invention disclosed and claimed herein, in one aspect thereof, comprises a method of authenticating a consumer and authorizing a transaction over a network. The method includes first requesting, by a user, performance of a transaction between said user and a merchant, the user and the merchant performing the transaction over a non-secure web page. The user then enters transaction request information into a non-secure general purpose computer, and then enters a PIN into a graphic interface of the non-secure web page on the non-secure general purpose computer. The non-secure general purpose computer provides the transaction request information and a PIN data package, the PIN data package being a digital representation of an impression of the users selection of at least one graphic image representing the user's PIN to a secure transaction manager via an Internet system. The transaction manager combines at least one of transaction data, dynamic data and corollary data with the PIN data package and securely provides the combination to a hardware security module (HSM). The HSM distills the PIN data package into a PIN and encrypting the PIN into a PIN Block. Thereafter; the remainder of the transaction is performed.

The secure authentication of the consumer to their demand deposit account (DDA) enables secure payments against the DDA for Internet or other open network transactions on, for example, an non-secure computer conducting transactions over a non-secure web page.

### BRIEF DESCRIPTION OF THE DRAWINGS

For a more complete understanding of the present invention and the advantages thereof, reference is now made to the following Detailed Description taken in conjunction with the accompanying Drawings in which:

FIG. 1 illustrates an exemplary on-line commercial transaction;

FIGS. 2A and 2B illustrate an exemplary communication flow for a secure PIN process;

FIGS. 3A, 3B, 3C and 3D provide flowcharts that illustrate an exemplary PIN processing process;

FIG. 4 is an exemplary system for authorizing a transaction involving a demand deposit account;

FIGS. 5A, and 5B depict an exemplary electronic check authorization protocol;

FIG. 6 is a general embodiment of an exemplary authentication system;

FIG. 7 is an exemplary embodiment of an authentication process;

FIG. 8 is a flow chart of an exemplary PIN capture process;

FIG. 9 is a flow chart of an exemplary authentication process;

FIG. 10 is a flow chart of an exemplary transaction authentication process;

FIG. 11 is an exemplary initialization process;

FIG. 12 is a flow chart of an exemplary PIN capture process;

FIG. 13 is a flow chart of an exemplary biometric authentication process;

FIG. 14 is a flow chart of an exemplary PIN capture process;

FIG. 15 is a block diagram of an exemplary PIN transaction system;

FIG. 16 is a flow chart of an exemplary PIN transaction process;

FIG. 17 is a flow chart of another exemplary PIN transaction process;

FIG. 18 is a flow chart of an exemplary PIN capture process;

FIG. 19 is a flow chart of an exemplary PIN utilization process;

FIG. 20 is a block diagram of an exemplary PIN processing system;

FIG. 21 is a diagrammatic representation of a negotiable instrument;

FIG. 22 is a block diagram of an exemplary check payment system;

FIG. 23 is a flow chart of an exemplary check payment process;

FIG. 24 is a block diagram of an exemplary PIN capture system;

FIG. 25 is a flow chart of an exemplary PIN service process;

FIG. 26 is a block diagram of an exemplary a check authentication system;

FIG. 27 is a block diagram of an on-site ATM merchant transaction system;

FIG. 28 is a flow chart of an exemplary ATM process;

FIG. 29 is a block diagram of an Internet credit transaction system;

FIG. 30 is a flow chart of an exemplary network transaction process;

FIG. 31 is a block diagram of an ATM transaction system;

FIG. 32 is a flow chart of an ATM transaction process;

FIG. 33 is a block diagram of an exemplary check processing system;

FIG. 34 is a block diagram of an exemplary credit processing system;

FIG. 35 is a flow chart of an exemplary credit transaction process;

FIG. 36 is a block diagram of an Internet transaction processing system;

FIG. 37 is a flow chart of an exemplary transaction provider process;

FIG. 38 is a flow chart of an exemplary transaction process;

FIG. 39 is a flow chart of another exemplary transaction process;

FIG. 40 is a flow chart of yet another exemplary transaction process;

FIG. 41 is a flow chart of still another exemplary transaction process;

FIG. 42 is a flow chart of an exemplary secure PIN collection process;

FIG. 43 is a flow chart of an exemplary of a PIN collection process;

FIG. 44 is a flow chart of another PIN collection process;

FIG. 45 is a flow chart of yet another PIN collection process;

FIG. 46 is a flow chart of an additional exemplary transaction process; and

FIGS. 47A, 47B and 47C are flow diagrams describing the manner in which an imprint or impression of the PIN is generated and transmitted.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

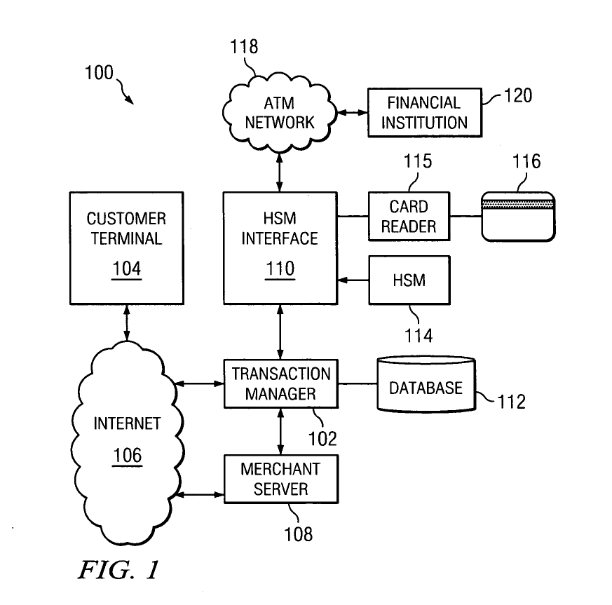

Referring to FIG. 1, an exemplary on-line commercial transaction is depicted. In an on-line commercial transaction process, a customer using a customer terminal 104 is connected to an open network 106 such as the Internet. The customer terminal 104 is preferably a personal computer at use in a home or office. It should be understood that the customer terminal 104 may be any digital device that can be communicably connected to an open network 106 and is capable of receiving data input by the customer and processing the data input by the customer before transmission to the open network 106.

Typically, the customer at the customer terminal 104 is connected to a merchant server 108 via the Internet 106. The merchant server 108 may offer goods or services for sale to the customer, with one or more web pages serving as consumer interfaces. When the customer has made appropriate selections at the merchant web site, payment options are typically given to the customer. Communication between the customer terminal 104 and the merchant server 108 will typically be conducted using a secure socket layer (SSL) connection, although the security of the transaction communication may be in accordance with another protocol or even made in the clear, depending on the security needs dictated by the specific transactions and protocols. In accordance with the present embodiment, when a debit-type transaction where money is transferred from a customer bank account at a financial institution 120 via the ATM network 118 is selected, the transaction is initiated, typically by a transaction initiation message sent from the customer terminal 104 through the open network 106 to the merchant server 108.

When a transaction initiation message is received at the merchant server 108, the merchant server 108 communicates the transaction initiation, including transaction details, merchant details and customer details, to the transaction manager 102. Communications between the merchant server 108 and the transaction manager 102 are typically conducted using a dedicated communication network or a virtual private network (VPN). Some communications between the merchant server 108 and the transaction manager 102 may be conducted via the open network 106, but because of the confidential nature of the financial transaction, communication between the merchant server 108 and the transaction manager 102 will typically use a secured connection.

The merchant server 108 will establish a connection between the customer terminal 104 and the transaction manager 102. This connection will typically be established in such a way that the customer at customer terminal 104 is generally unaware that the customer is communicating with the transaction manager 102 instead of the merchant server. However, once the connection is established between the customer terminal 104 and the transaction manager 102, the merchant server 108 is privy to none of the data exchanged between the customer terminal 104 and the transaction manager 102. This protocol prevents the merchant server 108 from intercepting the communications between the customer terminal 104 and the transaction manager 102 and gaining access to confidential financial or personal data, as well as preventing man-in-the-middle attacks on the system.

The transaction manager 102 is communicably connected to a transaction manager database 112. The transaction manager database 112 stores algorithms and other data used in the transactions. When the customer terminal 104 initiates a first transaction, the transaction manager 102 retrieves a copy of a transaction module from the transaction manager database 112 and sends a transaction module to the customer terminal 104. The transaction module secures the customer terminal 104 and regulates the transaction process at the customer terminal 104. The transaction manager database 112 may store algorithms used to generate a dynamic PIN input interface, encryption algorithms, components of encryption algorithms and other data used as unshared secrets. The algorithms and data stored in the transaction manager database may be organized in families of data, such that when a family is available to a transaction module, the processing steps may be chosen by identifying portions of the family and with data to determine the variables used in the creation of corollary data.

The transaction manager 102 is communicably connected to a Hardware Security Module (HSM) interface 110. The HSM interface 110 may be a secure configuration terminal (SCT). The connection between the transaction manager 102 and the HSM interface 110 is typically a secured line connection. The HSM interface 110 is connected directly to an HSM 114. The HSM 114 or the HSM interface 110 may include an card reader 115 for reading data from a key card 116.

In accordance with the preferred embodiment, the Hardware Security Module 114 is a programmable or intelligent HSM. A programmable HSM is, generally, an HSM that is capable of interpreting injected data as programmatic instructions. Programmatic instructions may refer to executable images like an application written in a programming language such as assembly code, C or C++. Runtime images like a JAVA application may be used as programmatic instructions.

By programming the intelligent HSM, the HSM may implement programmed behavior either statically or dynamically. In this way, the HSM may be programmed to securely interact with the cryptography functions of the HSM. Applications may be downloaded into the HSM using any secure methodology. For example, the applications may be input into the HSM using a serial port, a network adaptor, smart cards, floppy disks, cd-ROMS, an infrared port or any other known input mechanism. In accordance with the preferred embodiment, a smart card 116 may be used to inject algorithms, keys or other secure data into the HSM 114.

The executable code injected into the HSM 114 is typically authenticated using a digital signature of the executable code generated by an authorized publisher. Other authentication methods may be used. The executable image, when executed, is programmed so that data is exchanged between the HSM 114, the HSM interface 110 and other connected systems in a secure manner. In particular, the programming prevents compromise of the HSM 114 including the algorithms and keys stored therein. The HSM 114, in accordance with the preferred embodiment, is capable of both reading and writing to a smart card 116, or other portable token or identification device.

The HSM 114 is, in accordance with the preferred embodiment, a Tamper Resistant Security Module (TRSM), preventing physical as well as logical intrusion. Using approved software components, a customized secure configuration terminal (SCT), ACL definitions, policies and procedures, the programmable HSM 114 can be made to meet X9 key management requirements. In particular, the HSM 114 can perform X9 compliant key exchange keys, split knowledge key management, dual control, key fragments, key pair generation, key injection, key combining, key exchange, key loading, key recovery, destruction of keying material, key management with encrypted keys, PIN block creation, PIN block translation, PIN management with encrypted PIN. The HSM 114 may be an X9 compliant tamper proof enclosure with key destruction when the enclosure of the HSM has been compromised. Policies and procedures for these processes can thus be audited and are verifiable.

The HSM 114 may be encased in a durable, tamper-resistant casing to protect the system against intrusion, with built-in detection features capable of sensing sophisticated attempts at physical or electronic tampering. An unauthorized attempt to access the HSM results in the immediate and automatic erasure of the secured algorithms and data stored in the HSM 114. The HSM 114 is a TRSM capable of enforcing key confidentiality and separation. The HSM 114 allows dual control, tamper detection and active countermeasures such as automatic key erasure upon compromise. These types of devices and environmental security measures currently exist in many systems of financial institutions, network processing centers and military installations.

The HSM 114 may also use access control lists to allow fine-grained control over key separation, key injection and key management. The HSM 114 will preferably be programmed so that it will only accept authenticated trusted code provided by an authenticated trusted publisher. Authentication of the trusted code and trusted publisher is typically achieved using an appropriate digital signature authentication protocol.

The HSM 114 may be programmed to refuse to load trusted code during key loading processes. The HSM 114 may be programmed to restrict code loading in accordance with X9 audit procedures. The HSM 114 should pass FIPS-140 validation requirements. The HSM 114, in conjunction with an SCT and approved key management practices allow for the management of keys for injection into devices that are physically or geographically separate, as may be required for business continuance best practices. The HSM 114, in conjunction with an SCT, can meet or exceed all key management practices required by the X9 TG-3 audit guidelines or associated standards.

To make the HSM 114 compliant with X9 requirements, the programmed HSM 114 requires that private keys and symmetric keys exist in an acceptable secure format. The keys may be rendered as cleartext inside the protected memory of a tamper resistant security module, or encrypted when rendered outside of the protected memory of a tamper resistant security module. The keys may be rendered as two or more key fragments or key components either in cleartext or ciphertext and managed using dual control with split knowledge fragmentation of the keys. Secret-sharing enables the key fragments to be stored separately on tokens so that less than all of the key fragments (k-of-n key fragments) are required to load or reconstitute the key being protected. Good security practice requires key separation, whereby each key or key pair is generated for a particular purpose and used solely for the purpose for which it was intended.

The HSM interface 110 may be interfaced directly or indirectly with the HSM 114 for loading the key-encryption-key (KEK), key pairs as well as any other activity necessary to meet X9 standards for key management. Accordingly, the HSM interface 110 may be connected directly to the HSM 114, for example using an SCSI, IDE, serial port, parallel port, USB port, keyboard, mouse, or firewire port. The HSM interface 110 may be connected indirectly to the HSM 114, for example using an infra-red port. The HSM interface 110 may be interoperable with the HSM 114 via use of smart cards with supporting processes and procedures to insure key management policies and procedures can be implemented. Future connection methodologies that comport with the required standards may also be used.

The HSM interface 110 may be encased inn a durable, tamper-resistant casing to safeguard the system against incursion. The HSM interface 110 should also include built-in detection techniques capable of sensing sophisticated attempts at physical or electronic tampering. These techniques may provide for immediate and automatic erasure of secured algorithms and data stored in the device.

In accordance with one embodiment, the HSM interface 110 may provide graphics display, allowing it to support a variety of graphic character sets, including Japanese, Chinese, Arabic and Cyrillic-based languages. The display may be configured to show two lines of Chinese prompts, two lines of large characters or up to four lines of Roman text. The HSM interface 110 may be capable of displaying two languages simultaneously, such as French and English, for use in multi-lingual environments.

The HSM interface 110 may be configured to support custom application development and remote downloading of an executable image. The download process will typically require a trusted code source and use executable code that is authenticated, through a digital certificate, hash, MAC or other methodology sufficient to prove the authenticity and integrity of the executable code.

The HSM interface 110 may provide access control using smart cards, token devices, passwords or other methodology. Access control is used to insure that code downloads can only be accomplished by authorized trusted entities. Use of the HSM interface 110 may be restricted using access control. Key loading is restricted to authorized parties using access control. Key injection is restricted to authorized parties using access control. Software download is restricted to proprietary protocols and otherwise restricted using access control.

The HSM interface 110 insures that access to any keying information entered can not be controlled or denied to one or all users of the HSM 114. The HSM interface 110 may provide an interface for the HSM 114. The HSM interface 110 may provide simultaneous support for multiple key management functions. The HSM interface 110 may provide comprehensive software security and tamper-proof casing. The HSM interface 110 may store keys securely in a security chip. The HSM interface 110 may include the ability to wipe keys from the security chip upon completion of keying activity if required. The HSM interface 110 may provide secure communications between a keyboard, a display and a security module. The HSM interface 110 may provide a PIN pad that supports alpha-numeric entry. The HSM interface 110 may provide a smart card reader and writer supporting a plurality of asynchronous and synchronous memory and protected-memory cards. The HSM interface 110 may include a magnetic strip reader that can read and write Track 1 and 2 or Track 2 and 3. The HSM interface 110 may provide a serial interface.

The HSM interface 110 smart and magnetic card reader 115 may provide a secure and verifiable erasure feature to insure no residual keying material exists after keys have been injected or keying material has been discarded. This may be implemented as a procedure that requires erasure of the material be performed and verified to substantive level. The card reader and writer 115 may support both EMV for smart card support, debit cards, credit cards, and ATM cards.

The HSM interface 110 may be both physically and electronically secure, and may contain an integral security module, with an encryption chip, that offers simultaneous support for encryption and key management functions. The security module may be provided to work with DES, Triple DES, RSA, AES, ECC encryption, and supports Master/Session Key, DUKPT (derived unique key per transaction) and regional key management methods.

The HSM interface 110 may provide additional features that are not required to secure the HSM 114, as the device may include higher order utility capabilities for acting as a PIN pad in online and offline debit transactions.

The HSM interface 110 is communicably connected, typically by a secure line connection, to a closed network 118 such as the ATM Network. This closed network 118 provides communication to one or more financial institutions 120. Transaction for the transfer of monies from one account to another is performed by communications transmitted through the ATM Network 118.

In typical prior art systems, using software-based cryptography, all of the cryptographic components (i.e., algorithm, key, cleartext, ciphertext) reside in unprotected memory, where they are susceptible to duplication, modification, or substitution. The most susceptible element is the cryptographic key. A duplicated key allows an attacker to recover all encrypted data. In addition a duplicated asymmetric private key allows an adversary to falsely generate digital signatures that would be attributed to the computer owner. A substituted or modified public key would allow a “man-in-the-middle” attack such that the adversary could intercept and change e-mails or transaction data undetectable by the sender or receiver.

In the hardware-based cryptography, physical and logical barriers limit data access, while the algorithm and key are kept secure in the protected memory of the HSM 114. Thus, hardware based cryptography ensures the confidentiality, integrity, and authenticity of cryptographic keys and, further, provides assurance regarding the integrity and authenticity of the cryptographic algorithm, which reinforces the overall level of security.

The secure PIN processing system 100 insures that the key management policies, practices and life cycle controls which deal with an organization's policies and practices regarding the management of private asymmetric keys, symmetric keys, and other types of keying material (e.g., pseudo-random number generator seed values), including cryptographic hardware management. Key management life cycle control information should be disclosed to allow relying parties to assess whether the organization maintains sufficient controls to meet its business requirements and insure key generation practices, such that cryptographic keys are generated in accordance with industry standards.

The secure PIN processing system 100 manages the random or pseudo-random number generation process, prime number generation, key generation algorithms, hardware and software components. The secure PIN processing system maintains adherence to all relevant standards as well as references to the key generation procedural documentation including key storage and backup. Asymmetric private keys and symmetric keys remain secret and their integrity, authenticity and recovery practices may be retained. The secure PIN processing system 100 allows the use of key separation mechanisms using hardware and software components. This permits provable adherence to all relevant standards and provides references to key storage, backup, and recovery procedures. The secure PIN processing system 100 controls the initial key distribution processes, subsequent key replacement processes, and key synchronization mechanisms.

The secure PIN processing system 100 relies on the HSM 114 not just for security by also to insure the cryptography which is CPU intensive is optimized for high scalability and is capable of supporting diverse applications. The secure PIN processing system and process 100 may dramatically increase the number of cryptographic keys generated, distributed, installed, used, and eventually terminated. This proliferation will stress the scalability of key management software and the key storage mechanisms that will be forced to manage more and more cryptographic keys.

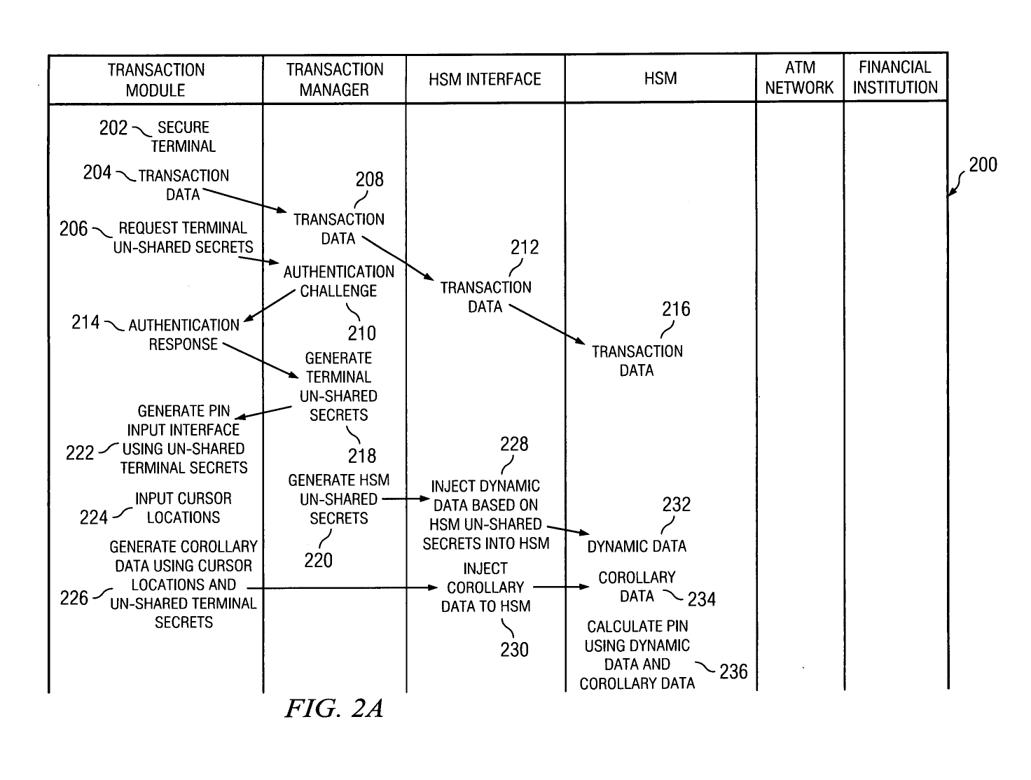

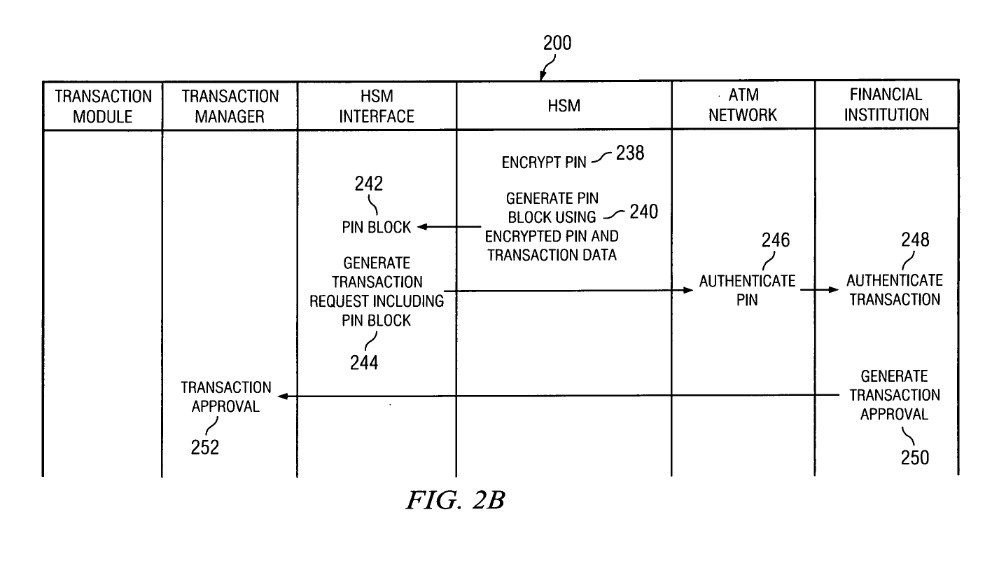

With reference to FIGS. 2A and 2B, a communication flow chart for the secure PIN process 200 is shown. When the transaction module is executed, the transaction module performs a procedure for securing the customer terminal 104 in step 202. The process for securing the customer terminal 104 may include checking the location, registry and memory of the customer terminal 104. The transaction module checks to see if there is any indication that the transaction process may be rendered insecure by the customer, customer software or customer hardware. A port scan is performed. The customer terminal 104 interrupts and vectors are checked. The transaction module searches for hardware crackers. The goal is to insure that the customer terminal 104 is a generic computer running generic software. If the transaction module determines that the customer terminal 104 is for any reason insecure, the transaction process is terminated.

When the customer terminal is determined to be secure, the transaction module sends transaction data to the transaction manager 102 in step 204. Some or all of the transaction data may be sent by the transaction manager 102 to the HSM interface 110 in step 212. Some or all of the transaction data may also be sent by the HSM interface 110 to the HSM 114. The specific transaction data shared by the transaction module, transaction manager 102, HSM interface 110 and the HSM 114 depends on the particulars of the protocols underway.

The transaction module requests terminal unshared secrets from the transaction manager 102 in step 206. Typically, the transaction manager 102 sends an authentication challenge to the transaction module in step 210. An authentication response is sent by the transaction module to the transaction manager 102 in step 214. The interchange of authenticating data may be performed in a variety of ways. The authentication may be bi-directional, such that the traction module is authenticated to the transaction manager 102 and the transaction manager 102 is authenticated to the transaction module. The authentication may take place at other times during the process, and may be repeated in some protocols. Because the identity of the participants are especially important in a financial transaction, a wide variety of authentication protocols and procedures may be implemented to accomplish that goal.

The transaction manager 102 generates terminal unshared secrets in step 218 and HSM unshared secrets in step 220. The terminal unshared secrets are used to allow the transaction module to properly form and encode corollary data used to identify the PIN of the customer. The HSM unshared secrets are used by the HSM 114 to convert the corollary data into the customer PIN. The unshared secrets may include algorithms, portions of algorithms, families of algorithms, identifiers for selecting algorithms, portions of algorithms or families of algorithms. The unshared secrets may include data to modify the algorithms. Variables may be established by the unshared secrets.

The transaction manager 102 sends the terminal unshared secrets to the transaction module and send the HSM unshared secrets to the HSM 114. The transaction module generates a graphical PIN input interface for display on the customer terminal 104 using the unshared terminal secrets in step 222. The customer selects displayed portions of the graphical PIN input interface using a mouse to generate cursor location data in step 224. In accordance with the preferred embodiment, the graphical PIN input interface includes a graphical display of a numeric keypad, such the customer selects a digit of the PIN by clicking a mouse button when the mouse cursor is over the appropriate numeral. With each entered digit, the displayed keypad may be scrambled, such that a given mouse cursor location may indicate a different numeral with each entered digit. The cursor location data for each digit of the PIN is recorded by the transaction module. The transaction module then generates corollary data using the cursor location data and the unshared terminal secrets in step 226. The corollary data is sent to the transaction manager 102 which further sends the corollary data to the HSM interface 110.

The HSM interface 110 injects dynamic data into the HSM 114 using the unshared HSM secrets in step 228. The HSM interface 110 injects the corollary data into the HSM 114 in step 230. The HSM 114, using the transaction data 216, the dynamic data 232 and the corollary data 234, calculates the customer PIN in step 236.

The HSM 114 encrypts the PIN in step 238. The HSM 114 generates a PIN block using the encrypted PIN and transaction data in step 240. The HSM 114 sends the PIN block to the HSM interface 110 in step 242. The HSM interface 110 generates a transaction request including the PIN block in step 244 and sends the transaction request to the ATM Network 118. The ATM Network 246 or the financial institution 120 authenticates the PIN in step 246. The financial institution 120 authenticates the transaction in step 248. The financial institution 120 then generates a transaction approval message in step 250 and sends the transaction approval message to the transaction manager 102 in step 252. The transaction manager 102 notifies the merchant server that the transaction has been processed.

It is important for various exemplary embodiments of the invention to enable use of a debit or ATM card upon acquisition of a PIN from a user or other user articulated token when operating in an a open network environment, such as the internet, while using a browser or software that is operating on the customer's or user's general purpose computer. The debit or ATM card, along with the PIN, can be entered into a graphic user interface on the screen on the general purpose computer by the user. In other embodiments, the merchant may already know or have access to the user's debit or ATM card information. Thus, only the PIN need be entered by the user into the graphic user interface on the Internet browser of the general purpose computer. The debit or ATM card information along with the PIN is presented to the processor. The processor is the receiver of a transaction such as a purchase of an item over the Internet. The processor authenticates the identity of the card holder. That is, the combination of the ATM or debit card information along with the graphical user interface representation or impression of the PIN provide a nonspecific representation of the PIN that is passed to the processor for authentication. The graphical user interface representation of the PIN may be called a PIN data package. A PIN data package is a digital representation of an impression of the user's selection of at least one graphic image representing the user's PIN. The PIN data package may also be thought of as the digital data associated with the users use of the graphic interface when the user entered the PIN into the general purpose computer. The processor can receive the PIN data package distill into the user's actual PIN that the user believed was entered into graphical user interface (i.e. the user's impression of the PIN), but was, in fact, a digital or graphical non specific representation that was passed over the open network, usually in a cryptographic manner, to the processor. The PIN, in combination with the debit or ATM card information has been used within a secure HSM, that complies with the cryptographic standards government online debit transactions that are generally understood by those debit or ATM networks, in order enable completion of the transaction. It is understood that an ATM network, for purposes of embodiments of this inventions, is equivalent to an EFT network.

In some embodiments of the invention the HSM 114 and an associated HSM interface 110 operate in coordination with a transaction manager 102 in order provide an ACH style transaction. An ACH is an automated clearing house, that is known in the transaction industry. An ACH may also be or include related or similar transaction style clearing houses or be performed directly against accounts that include, but are not limited to, a SWIFT transaction, a Fed-wire transaction or an RTGS transaction.

The use of a debit card and user's PIN initiates the transaction with the processor (the party that is in receipt of the transaction between a user and a merchant). Initialization of a transaction with both a debit card and a user's PIN allows the processor to begin authorizing or inquiring against the debit card-PIN combination in order to attempt to authenticate the user for the ATM network. The results from an authorized transaction provide the processor with the account number of the demand deposit account (DDA) of the user so that the processor knows where finds should be debited from. It is understood that a debit card may have an affinity for more than one DDA. However, the standard process model for debit card transactions utilizes a default affinity for one DDA over any other DDA's that the card may be used for.

Since the processor has the benefit of a secure communication connection with the ATM network and has the ability to authenticate the debit and ATM card holders, then the processor can also look up a routing number for the authenticated debit card by virtue of the bank identification number (BIN), which has a one-to-one relationship to the issuing entity in the underlying routing number.

In another embodiment of invention, authentication of a user is performed by requesting that the user (consumer) enter in the routing number of their financial institution on the graphic user interface of the web page where they are making the transaction. In this situation, a bank identification number (BIN) could be a cross referenced for a validation, because a financial institution's routing number is common across all similar BIN's and checking accounts drawn on that particular institution. This effectively makes the routing number a public value, while the user's PIN is a secret value known only by the consumer or the user.

The benefits of maintaining and keeping the PIN a secret from all the parties except the legitimate holder of the debit card (the user/consumer) is that all the protections of the PIN are retained and the benefits of the PIN are enforceable. Specifically, if a PIN number is kept secret by the legitimate debit card holder, a PIN-authenticated-transaction performed in combination with a debit card will be non-reputable and will be able to operate as an electronic signature recognized by the federal regulations for banking under Reg E, and be universally protected world wide by cryptography standards.

In other embodiments of the present invention, a biometric device may be used along with a PIN rather then using a debit, ATM, credit card, or other electromechanical token or device in possession of the user. Biometrics usually refers to technologies for measuring and analyzing human body characteristics such as fingerprints, eye retinas and irises, voice patterns, facial patterns, blood vessel organization, capillary behavior, DNA, body fluid, and hand measurements. Fingerprint and other biometric devices generally consist of a reader or scanning device, software or hardware that converts the scanned information into digital form, and wherever the data is to be analyzed, a database that stores the biometric data for comparison with previous records. When converting a biometric input, the software identifies specific points of data as match points. The match points are processed using an algorithm into a value that can be compared with biometric data scanned when a user tries to gain access. Fingerprint, facial, or other biometric data can be placed on a smart card-debit card and users can present both the smart card-debit card and their fingerprints or faces to merchants, banks, or telephones for an extra degree of authentication.

In an exemplary embodiment, the biometric device may be contained in, in communication with or connected to the general purpose computer and may have to be authenticated by either software within the general purpose computer or the processor. Furthermore the biometric data, acquired by the biometric device, can be authenticated by any one or more of the general purpose computer, the ATM network, a biometric authentication provider or network, a financial institution, a processor, and a third party. With the exception of the general purpose computer, all the biometric authentication means can be considered a biometric network. Once the biometric device is authenticated, if it is necessary, then the user may enter their PIN into a graphic user interface on the screen of the general purpose computer. The user and the transaction can then be authenticated and the user is provided access a “wallet” across the internet. A wallet is generally a logical container for containing information related to methods of payments consumer can make or has access to. The wallet may also contain information related to the consumers identification.

Information that can be found in a wallet includes, but is not limited to payor information, consumer identity information, medical information, and financial information. Customer identity information may include driver's license numbers, social security numbers, passport numbers, date of birth, address, citizenship information, identifying marking information, and graphic, audible or other identifying biometric information. Medical information may include health provider information, medical history information, and medical record release information, and emergency medical instruction information. And, financial information may include DDA, credit card, debit card, gift card, smart card, SWIFT, Fed-wire, trading account, brokerage account, or employment information.

In another embodiment, instead of using a general purpose computer, the computer may be a substantially secure device found in a merchant's store or kiosk device. The combination of the user providing a biometric input into the biometric device, the use of a PIN, and substantially secure communication pathways that can be authenticated will enable access to data stored in a consumer's virtual wallet, provider systems or other financial or non-financial systems where verification of the biometric input from a consumer is used to authenticate the consumer and, in some embodiments of the invention, authorize a transaction. Such an authorization of the consumer, in turn, enables the processor to acquire payment information that may be ACH, fed-wire, wire, credit, debit, PINless, or other non-payment oriented transactions from the consumer's protected information within the wallet. Such biometric related information may also allow a third party service to obtain access to the consumer's virtual wallet when presented with a request for authorizing payment to a merchant over the Internet. For example, the routing number, the account number, or card number required for the transaction can be extracted from the wallet and then presented as an ACH, fed-wire, wire, credit, debit, PINless, or other non-payment or delayed payment oriented transaction for payment.

It is further important to understand that a process of authenticating a user with only a biometric measurement, provides an ability to identify the authorizing user, but doesn't necessarily represent a completely secure access methodology. However, by incorporating the addition of using a PIN along with the biometric entry enables a two factor authentication. The PIN can be established via user selection, by being mailed by the service provider to the user, or by the banking institution itself. In the context of additionally securing the connectivity in authenticated devices, such as a biometric device or the general purpose computer, one would understand that such an embodiment of the present invention represents a three factor authentication. In the further event that the PIN is established under cryptographic controls, then the authentication mechanisms would be considered a level-four authentication schemes.

In another exemplary embodiment where a user has a PIN that has been protected and both a debit/ATM card and a PIN are presented to a terminal, such as a general purpose computer, that has been authenticated and where an participants in the transaction have been authenticated with communications between the participants that has been secured by one of more types of cryptograph (ECC, AES, SSL, RSA), then a secure ACH transaction can be initiated by the processor of the transaction without the actual DDA data being transferred between the parties. In this circumstance the ACH transaction that are Internet initiated may be considered non-reputable, may be used to enforce the underlying contract between the parties that the payment represents, and eliminates the information necessary for criminal elements to conduct a fraudulent ACH transaction over the Internet.

The reduction of fraudulent transactions is believed to be based on the exemplary embodiment's secure initiation of ACH payments by consumers who are conducting commerce on the Internet using one or more of the embodiments prescribed by the present invention.

Embodiments of the present invention provide a system that also allows for auditing of transactions because the transactions can be tracked to specific terminals. The tracking to and identification of a user associated with a specific terminal can be accomplished by using a unique ID that is found in each general purpose computer; the unique ID found on a mobile, cell, or other mobile device; a digitally signed or digitally unique piece of software; GPS data providing the location of the device and software as a functional of the logical and physical world; the transaction history of the user including: who, where, how often, and how much was bought (services or goods) in the past; who authorized the transaction (notary, subscription, access permission); forming a phychographic profile for the user's terminal, software, debit card, or biometric in order to ascertain a behavior characteristics of the consumer in order to apply decision techniques; or fraud and risk scoring as part of the authentication process. All this aids in providing a means for securing the communication over an open network with a user before any specific transactions, private or secret data is acquired or exchanged between parties. Other historic or behavior characteristics of the user that may be useful in for identifying the probability that the user “is the bonafide user” are the average transaction velocity (i.e. the number of transactions that generally occur in the given amount of time or with certain merchants on specific devices or cards), the number of concurrent access requests periods, the number of user PIN retries on inputs, and the distance or separated time frames between data entries (for example: a first entry in France at 9a.m. and a second entry in the United States at 10p.m.). It is important to understand that authentication of the user is an aspect of the exemplary embodiments of the present invention which enable a plurality of transactions that are described and depicted in Figures herein. The exemplary authentication techniques of a consumer or first party and the authorizations of transactions, discussed above, along with logical permutations thereof, are utilized in the electronic check verification via an ACH type transactions, biometric based transactions and other transactions discussed and depicted throughout this document.

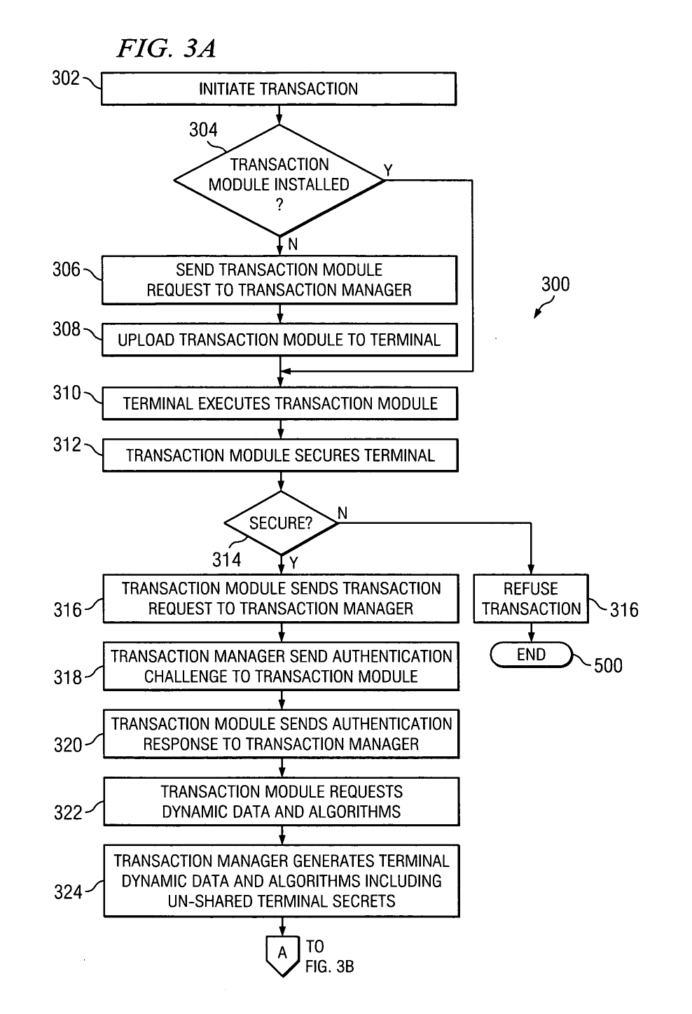

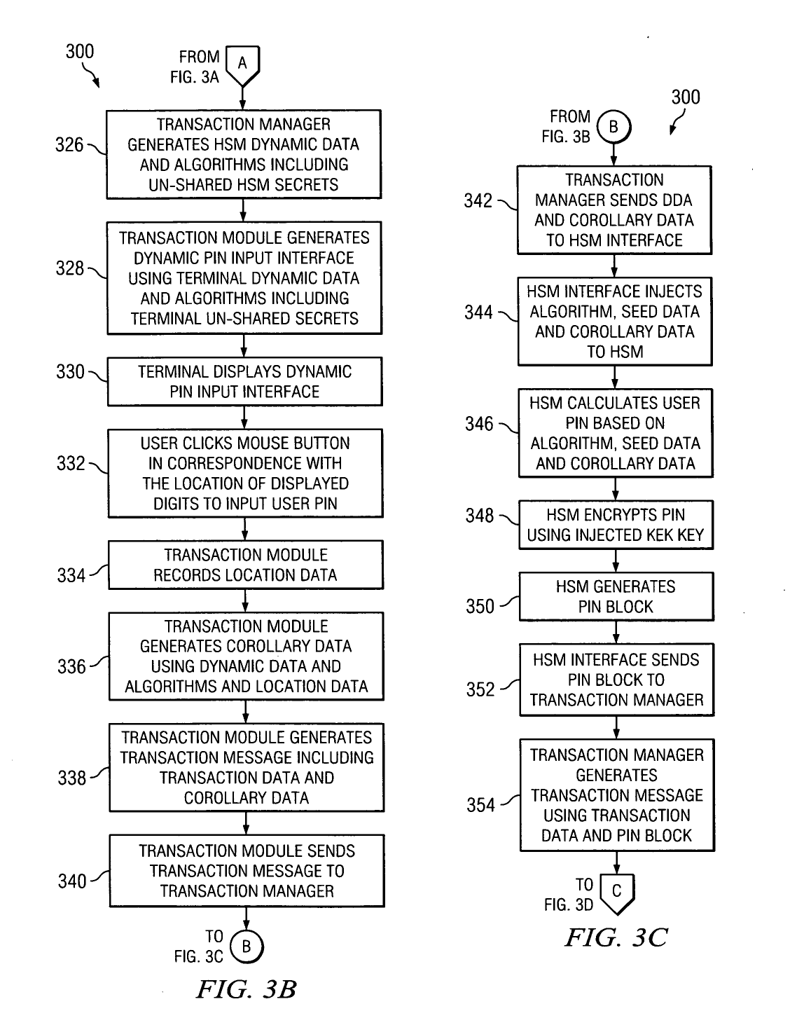

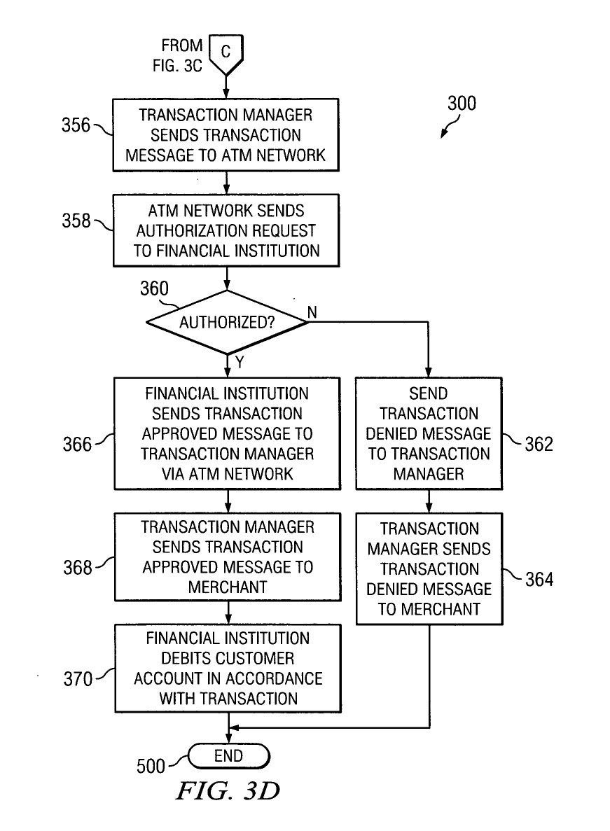

With reference to FIGS. 3A, 3B, 3C and 3D, a flowchart of an exemplary secure PIN processing process 300 is shown. The process begins as the transaction is initiated in function block 302. A check is done to determine if the transaction module has been installed at the customer terminal 104 at decision block 304. If a transaction module has not been installed, the process follows the NO path to function block 306, sending a transaction module request to the transaction manager 102. The transaction manager 102 retrieves the transaction module file from the transaction manager database 112 and uploads the transaction module to the customer terminal 104 at function block 308 and proceeds to function block 310.

If the transaction module was previously installed, the process follows the YES path to function block 310. At function block 310, the customer terminal 104 executes the transaction module. The transaction module then secures the customer terminal 104 at function block 312. A check is made to determine if the customer terminal 104 is secure at decision block 314. If the customer terminal is not secure, the process follows the NO path to function block 316 where the transaction is refused. The process then ends at block 500.

If the customer terminal is determined to be secure, the process follows the YES path to function block 316. The transaction module sends a transaction request to the transaction manager 102 at function block 316. The transaction manager 102 sends an authentication challenge to the transaction module at function block 318. The transaction module sends an authentication response to the transaction manager 102 at function block 320. If the authentication is not verified, the transaction is refused. The transaction module requests dynamic data and algorithms at function block 322. The transaction manager generates terminal dynamic data and algorithms including unshared terminal secrets at function block 324.

The transaction manager 102 generates HSM dynamic data and algorithms (DYDA) including unshared HSM secrets at function block 326. The transaction module generates a dynamic PIN input interface using terminal dynamic data and algorithms including unshared terminal secrets at function block 328. The customer terminal 104 displays the dynamic PIN input interface at function block 330. The user clicks the mouse button in correspondence to the location of a cursor over displayed digits in the dynamic PIN input interface in function block 332. The transaction module records the cursor location data at function block 334. The transaction module generates corollary data using the dynamic data and algorithms and the cursor location data at function block 336.

The transaction module generates a transaction message including transaction data and corollary data at function block 338. Proceeding to function block 340, the transaction module send the transaction message to the transaction manager 102. The transaction manager sends the dynamic data and algorithms and the corollary data to the HSM interface 110 at function block 342. The HSM interface 110 injects the HSM dynamic data and algorithms, seed data and corollary data to the HSM 114 at function block 344. Proceeding to function block 346, the HSM 114 calculates the customer PIN, based on the algorithms, seed data and corollary data. The HSM 114 encrypts the PIN using an injected key-encryption-key at function block 348. The HSM 114 may encrypt the PIN using any of a variety of encryption techniques. In accordance with the preferred embodiment, the encryption is performed using a dual-controlled, split-knowledge key, which has been injected into the HSM 114 using a smart card 116. The HSM 114 then generates a PIN block using the encrypted PIN at function block 350.

The HSM interface 110 sends the generated PIN block to the transaction manager at function block 352. The transaction manager 102 generates a transaction message using the transaction data and the PIN block at function block 354. The transaction manager 102 then sends the transaction message to the ATM Network 118 at function block 356. The ATM Network 118 sends an authorization request to the Financial Institution 120 at function block 358.

At decision block 360, the financial institution 120 determines if the transaction is authorized. If the transaction is not authorized, the process follows the NO path to function block 362 where financial institution 120 sends a “transaction denied” message to the transaction manager 102. The transaction manager 102 sends a “transaction denied” message to the merchant server 108 at function block 364. The process ends at block 500.

If the transaction is authorized, the process follows the YES path to function block 366. The financial institution 120 sends a “transaction approved” message to the transaction manager at function block 366. The transaction manager 102 sends a “transaction approved” message to the merchant server 108. The financial institution 120 debits the customer's account in accordance with the transaction data at function block 370. The process ends at block 500.

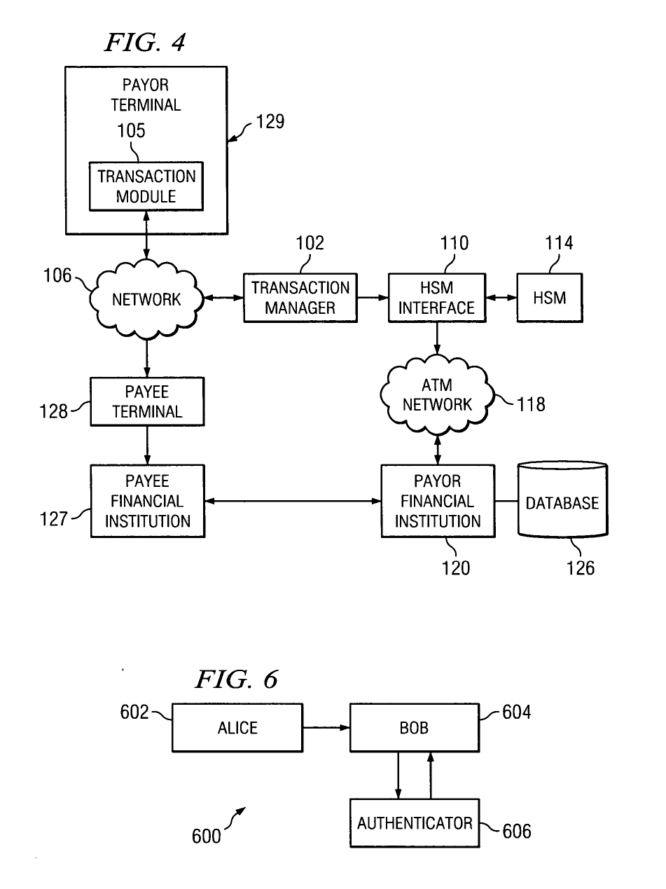

With reference to FIG. 4, an exemplary system for authorizing a transaction involving a demand deposit account is shown. In particular, a PIN Debit authorization is used to authorize electronic checks, automated clearing house transactions, and other forms of payment that are tied to a demand deposit account (DDA). In these types of transactions, a payor at a payor terminal 129 wants to authorize an electronic message identifying an amount of money and a payee. When the authorized electronic message is received by the payee at a payee terminal 128, the payee transfers the authorized electronic message to a payee financial institution 127, which requests the specified amount from the payor's financial institution 120. When the authorized electronic message is verified by the payor's financial institution 120, the specified amount is transferred to the payee's financial institution 127, where the specified funds are made available to the payee. Other protocols may be used for the presentation and payment of the specified amount, but in principle, the electronic message authorization process remains basically the same.

The payor terminal 129 includes a functioning transaction module 105, typically as software executed on the payor terminal 129 as previously described. The payor terminal 129 and the transaction module are connected to a network 106. Typically the network 106 will be an open network, such as the Internet, but the network 106 may be any suitable communication network. The network 106 may be connected to the payee terminal 128. A transaction manager 102 may be connected to the network 106. The transaction manager 102 may be connected to an HSM interface 110. The connection of the transaction manager 102 to the HSM interface 110 will typically be a direct connection, although network connections may also be used in suitable circumstances. The HSM interface 110 may be connected to an HSM 114. Typically the connection of the HSM interface 110 is direct and secured.

The HSM interface 110 may be connected to an ATM network 118. The ATM network 118 may be connected to the payor financial institution 120. The payor financial institution 120 may be connected to a payee database. The payee database may include data associating payee identification data with PIN numbers.

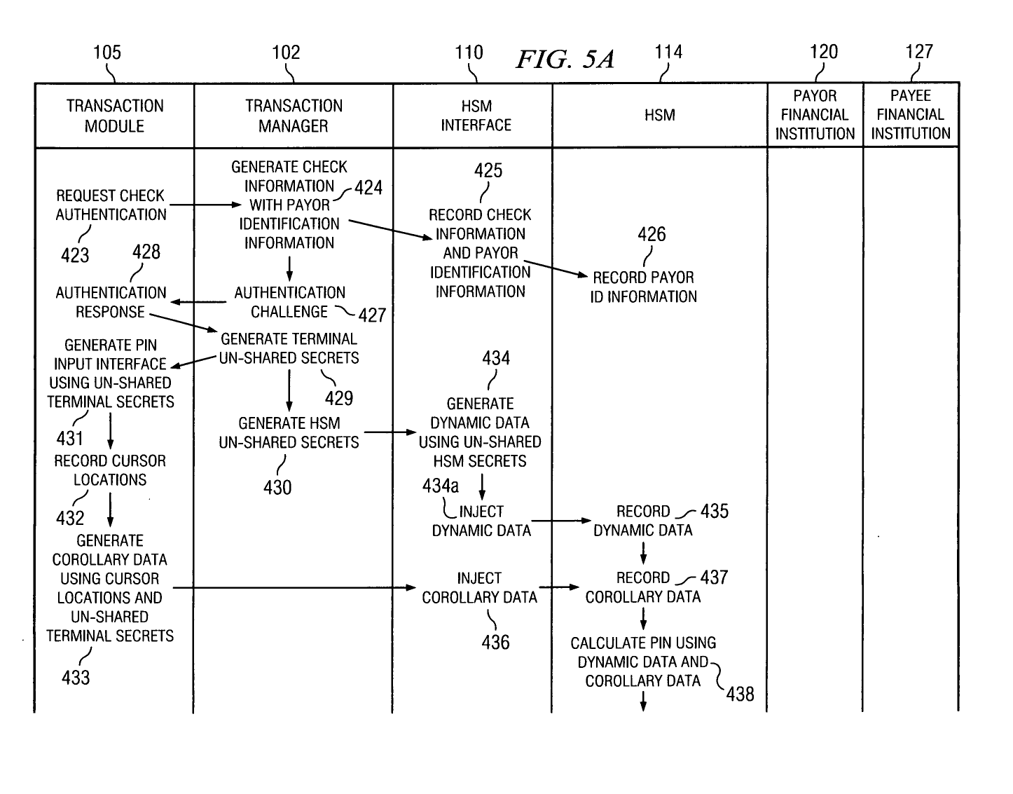

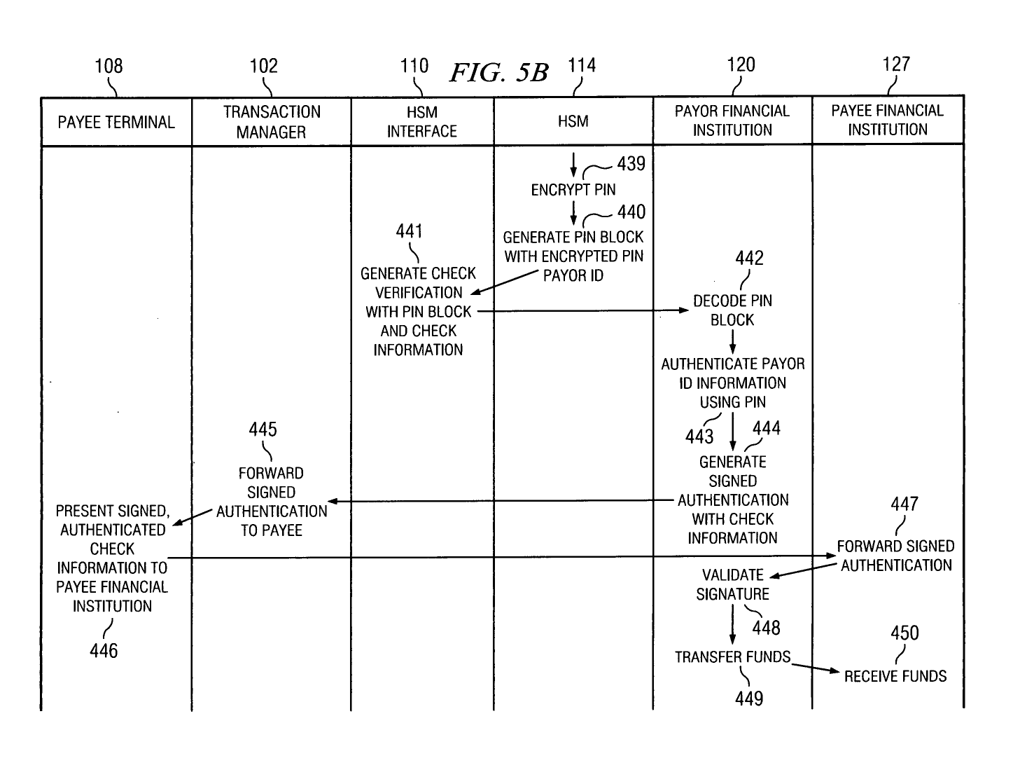

With reference to FIGS. 5A and 5B, a flow chart of an electronic check authorization protocol is shown. The process typically involves communications between a transaction module 105, a transaction manager 102, an HSM interface 110, an HSM 114, a payor financial institution 120, a payee financial institution 127 and a payee terminal 108.

The process begins when the payor at a payor terminal 129 requests a check authorization. The check authorization request may include a specified amount to be paid and a payee. The transaction module 105 on the payor terminal 129 sends the check authorization request to a transaction manager 102 in step 423. The transaction manager 102 may generate a check authorization information message and send it to the HSM interface 110 in step 424. The check authorization information message typically includes payor identification information such as the payor name and a demand deposit account number. The HSM interface 110 may record the check authorization information message including the check authorization request information and the payor identification information in step 425. The HSM interface 110 may send the payor identification information to the HSM 114, which may record the payor identification information in step 426.

The transaction manager 102 may generate and communicate an authentication challenge to the transaction module 105 in step 427. The transaction module 105 generates an authentication response and communicates the authentication response to the transaction manager 102 in step 428. The transaction manager 102 verifies the authenticity of the transaction module 105 based on the authentication response. When the transaction module 105 has been authenticated, the transaction manger 102 generates terminal unshared secrets and communicates the terminal unshared secrets to the transaction module 105 in step 429. The transaction module 105 receives the terminal unshared secrets and generates a PIN input interface using the unshared terminal secrets in step 431. The PIN input interface is displayed on the display of the payer terminal 129 and the payor is prompted to input cursor locations corresponding to the payor's PIN. The terminal module 105 records the cursor locations in step 432 and generates corollary data using the cursor locations and unshared terminal secrets in step 433. The corollary data is communicated to the HSM interface 110.

The transaction manager 105 generates HSM unshared secrets and communicates the HSM unshared secrets to the HSM interface 110. The HSM interface 110 generates dynamic data using unshared HSM secrets in step 434. The HSM interface 110 injects the dynamic data into the HSM 114 in step 434a and injects the corollary data into the HSM 114 in step 436. The HSM 114 records the dynamic data in step 435. The HSM records the corollary data in step 437.

The HSM 114 distills the payor PIN using the dynamic data and corollary data in step 438. The HSM 114 encrypts the PIN in step 439. Standard encryption techniques such as triple DES or any cytologically sufficient algorithm may be used to encrypt the PIN. The HSM 114 generates a standard PIN block using the encrypted PIN and the payor identification information in step 440. The PIN block is communicated to the HSM interface 110.

The HSM interface 114 generates a check verification message using the PIN block and check information in step 441. The check verification message is communicated via an ATM network to the payor's financial institution 120. The payor financial institution 120 decodes the PIN from the PIN block in step 442. The payor financial institution 120 authenticates the payor identification information using the PIN, typically be comparing the decoded PIN and payor identification information with values stored in a secured database 126. The payor financial institution 120 generates a signed authentication message using the check information. The signed authentication message may be generated using standard digital signature techniques.

Typically, the payor financial institution 120 communicates the signed authentication to the transaction manager 102. The transaction manager 102 receives the signed authentication message and typically forwards the signed authentication message to the payee in step 445. The payee terminal 108 receives the signed authentication message and presents the signed authentication message to a payee financial institution 127. The payee financial institution 127 typically presents the signed authentication message to the payor financial institution in step 447. The payor financial institution 120 may validate the signature in step 448. If the signature is valid and the check authorized by the authentication message, the payor financial institution 120 transfers specified funds from the payor account to the payee financial institution 127 in step 449. The payee financial institution 127 receives the funds and typically makes the available to the payee in step 450.

It will be recognized by those skilled in the art that the protocols for transferring monies from a payor to a payee may be configured in a variety of ways. The use of ATM authentication to provide a signature for an electronic check can be implemented in numerous ways, of which the described embodiment is only one. In particular, the interactions with the financial institutions and the methods of providing the monies to the payee may be performed in a variety of financially suitable ways.

With reference to FIG. 6, a general embodiment of an exemplary authentication system 100 is shown. When Alice's identity needs to be authenticated to Bob, Alice sends, 602 credentials to Bob, 604. Bob, 604 sends the credentials with Alice's identification information to a trusted authenticator 106. The authenticator 106 uses the credentials and ID information to authenticate Alice's identity. The result of the authentication is sent to Bob 604. If the authenticator 106 is able to authenticate Alice's identity, Bob 104 can trust Alice 602 in accordance with Bob's trust in the authenticator 606.

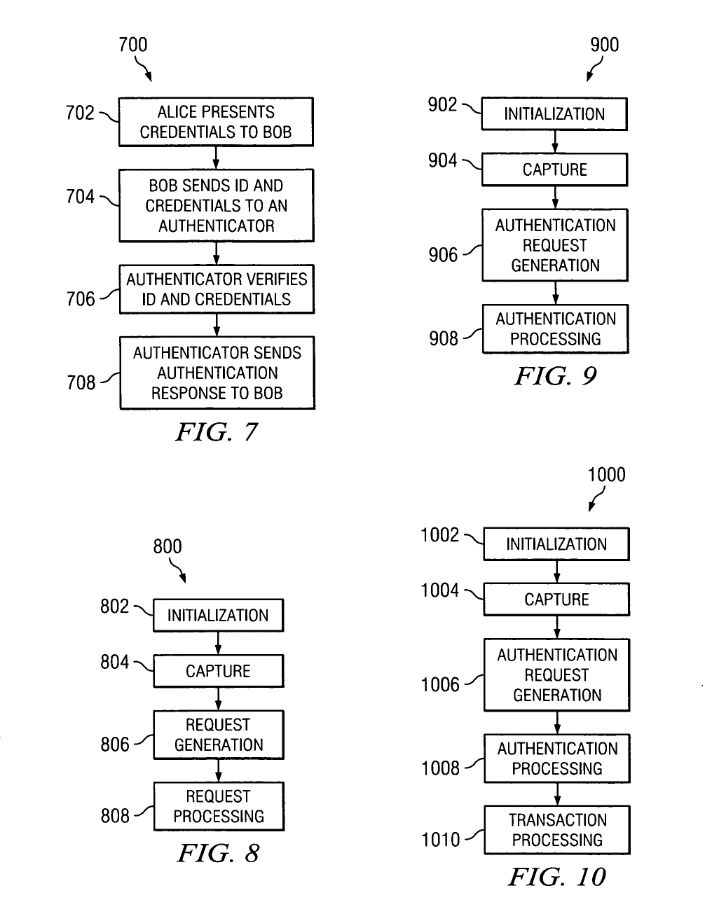

With reference to FIG. 7, an embodiment of an authentication process is shown. Alice presents credentials to Bob for authentication at function block 702. Bob sends ID information and Alice's credentials to a trusted authenticator at function block 706. The authenticator verifies the ID using the credentials at function block 206. The authenticator sends an authentication response to Bob at function block 708.

With reference to FIG. 8, a exemplary PIN capture process 800 is shown. A PIN capture process 800 begins with an initialization process at function block 802. A capture process captures the PIN at function block 804. A request is generated using the captured PIN at function block 306. The request is processed at function block 808.

A secure PIN processing system serves as apart of an on-line, internet commercial transaction process. It should be understood that the secure PIN processing system may be used in other network transaction environments, typically in processes where a party must be authenticated without an insecure transfer of authenticating data. A personal identification number (PIN) is generally a sequence of numerals, or characters where the number of digits creates a sufficiently high probability that a person in possession of the PIN can be positively identified as a specified person. PIN are most commonly known and, for example, are used in association with bank debit cards. Bank debits cards are used at automated teller machines (ATM's) connected to an ATM Network. When a customer presents the bank debit card to the ATM, the ATM prompts the customer to enter a PIN. The customer enters the PIN into the ATM. The ATM processes the PIN along with data read from the bank debit card to identify the customer presenting the card as the legitimate owner of the card.

For purposes of the disclosure, a PIN may be any sequence of numbers used, or characters as apart of an identification process, particularly where the identification is part of a transaction. Inasmuch as an ATM Network has specific requirements, the an exemplary embodiment is tailored to that use. It will be apparent to those having skill in the art that the same protocols can be used in a wide variety of situations, particularly situations where identification is part of a network transaction.

Debit cards are only one example of tokens that may be associated with a PIN. Credit cards, identification cards, key fobs, cellular telephones, personal digital assistants, biometric devices, computers, portable computers and computing devices, smart cards and passive or active transmitters are examples of various types of tokens that may also be identified along with a holder of a PIN. Serial numbers, passwords, biometric information, identification numbers, registration numbers, student identification numbers, network passwords, including numerals, characters or any graphic symbol, are examples of sequences that may act and function s a PIN.

With reference to FIG. 9, an exemplary authentication process 900 is shown. An initialization process is performed at function block 902. A PIN capture process is performed at function block 904. An authentication request is generated at function block 906. The authentication is processed at function block 908.

With reference to FIG. 10, an exemplary transaction authentication process 1000 is shown. An initialization process is performed at function block 1002. The PIN is captured at function block 1004. An authentication request is generated at function block 1006. The authentication is processed at function block 1008. The transaction is processed at function block 1010.

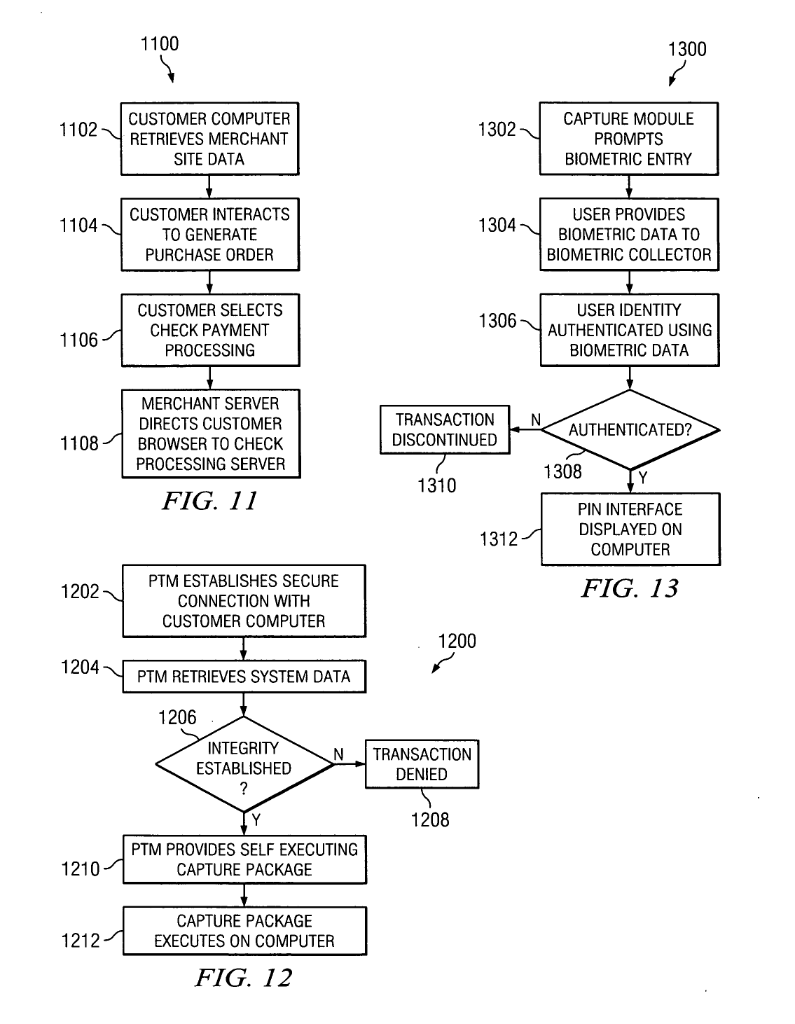

With reference to FIG. 11, an exemplary initialization process 1100 is shown. A customer computer retrieves merchant site data at function block 1102. The customer interacts with the merchant server to generate a purchase order at function block 1104. The customer selects check payment processing from a selection of payment options at function block 1106. The merchant server directs the customer browser to download site data from a check processing server at function block 1108.

With reference to FIG. 12, an exemplary PIN capture process 1200 is shown. A PIN transaction module (PTM) establishes a secure connection with a customer computer at function block 1202. The PIN transaction module retrieves system data from the customer computer at function block 1204. The PIN transaction module determines the integrity of the customer computer at decision block 1206. If the customer computer is violated, the process follows the NO path and the transaction is denied at function 1208. If the computer system is secured, the PIN transaction module provides a self-executing capture package to the computer at function block 1210. The capture package executes on the customer computer at function block 1212.

With reference to FIG. 13, an exemplary biometric authentication process 1300 is shown. The capture module prompts the customer for entry of biometric data at function block 1302. The user provides biometric data to a biometric collector at function block 1304. The user identity is authenticated comparing the collected biometric data to stored data at function block 1306. The authentication is determined at decision block 1308. If the customer is not authenticated, process follows the NO path and the transaction is discontinued at function block 1310. If the customer is authenticated by the biometric data, the process follows the YES path and a PIN interface is displayed on the customer computer at function block 1312.

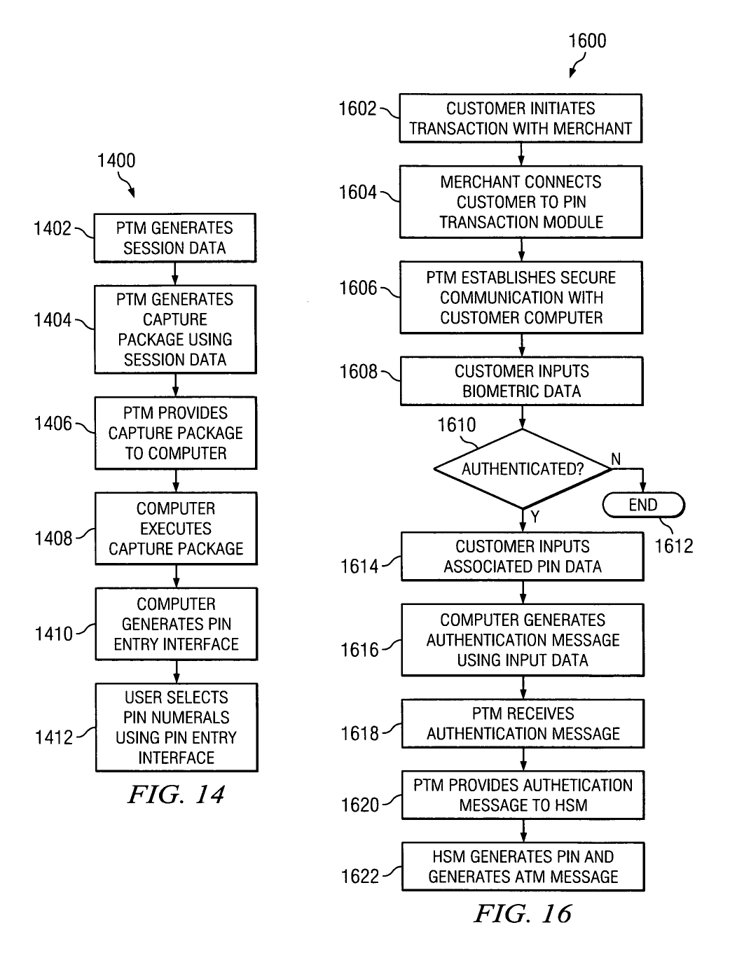

With reference to FIG. 14, an exemplary PIN capture process 1400 is shown. The PIN transaction manager 1400 generates session data at function block 1402. The PIN transaction module generates a capture package using the session data. The PIN transaction module provides the capture package to a customer computer at function block 1406. The computer executes the capture package at function block 1408. The computer generates a PIN entry interface at function block 1410. The user selects the numerals of the user's PIN on the PIN entry interface at function block 1412.

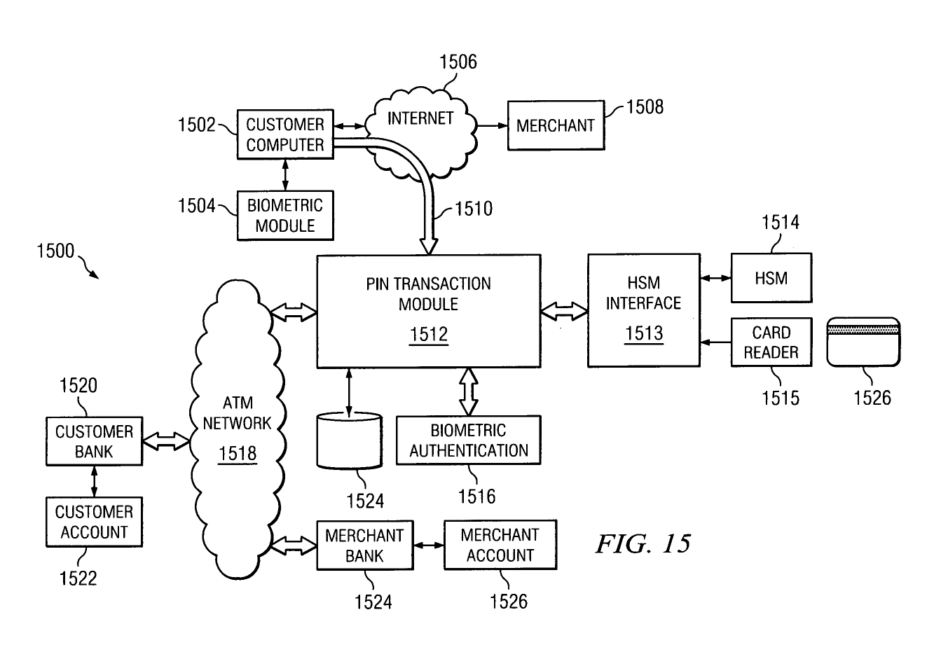

With reference to FIG. 15, an exemplary PIN transaction system 1500 is shown. A customer computer 1502 including a biometric module 1504 connects to a merchant 1508 over network 1506. The customer computer 1502 is securely connected to a PIN transaction module 1512 with SSL connection 1510. Other types of connections or protocols can be used in an exemplary system besides SSL. The PIN transaction module is securely connected to a security module 1114. Biometric authentication 1516 may provide information to the PIN transaction module 1512. A secure network 1518 provides messages from PIN transaction module 1512 to the customer bank 1520. Monies may be transferred from customer account 1522 at customer bank 1520 to the merchant account 1526 at a merchant bank 1524.

Typically, the customer at the customer terminal 1502 is connected to a merchant server 1508 via the Internet 1506. The merchant server 1508 may offer goods or services for sale to the customer, with one or more web pages serving as consumer interfaces. When the customer has made appropriate selections at the merchant web site, payment options are typically given to the customer. Communication between the customer terminal 1502 and the merchant server 1508 will typically be conducted using a secure socket layer (SSL) connection, although the security of the transaction communication may be in accordance with another protocol or even made in the clear, depending on the security needs dictated by the specific transactions and protocols. In accordance with the present embodiment, when a debit-type transaction where money is transferred from a customer bank account at a financial institution 1520 via the ATM network 1518 is selected, the transaction is initiated, typically by a transaction initiation message sent from the customer terminal 1502 through the open network 1506 to the merchant server 1508.

When a transaction initiation message is received at the merchant server 1508, the merchant server 1508 communicates the transaction initiation, including transaction details, merchant details and customer details, to the transaction manager 1512. Communications between the merchant server 1508 and the transaction manager 1512 are typically conducted using a dedicated communication network or a virtual private network (VPN). Some communications between the merchant server 1508 and the transaction manager 1512 may be conducted via the open network 1506, but because of the confidential nature of the financial transaction, communication between the merchant server 1508 and the transaction manager 1502 will typically use a secured connection.

The merchant server 1508 establishes a connection between the customer terminal 1502 and the transaction manager 1512. This connection is typically established in such a way that the customer at customer terminal 1502 is generally unaware that the customer is communicating with the transaction manager 1512 instead of the merchant server. However, once the connection is established between the customer terminal 1502 and the transaction manager 1512, the merchant server 1508 is privy to none of the data exchanged between the customer terminal 1502 and the transaction manager 1512. This protocol prevents the merchant server 1508 from intercepting the communications between the customer terminal 1502 and the transaction manager 1502 and gaining access to confidential financial or personal data, as well as preventing man-in-the-middle attacks on the system.

The transaction manager 1512 is communicably connected to a transaction manager database 1524. The transaction manager database 1524 stores algorithms and other data used in the transactions. When the customer terminal 1502 initiates a first transaction, the transaction manager 1512 retrieves a copy of a transaction module from the transaction manager database 1524 and sends a transaction module to the customer terminal 1502. The transaction module secures the customer terminal 1502 and regulates the transaction process at the customer terminal 1502.

The transaction manager database 1524 may store algorithms used to generate a dynamic PIN input interface, encryption algorithms, components of encryption algorithms and other data used as unshared secrets. The algorithms and data stored in the transaction manager database may be organized in families of data, such that when a DDA family is available to a transaction module, the processing steps may be chosen by identifying portions of the DDA family and with data to determine the variables used in the creation of corollary data.

The transaction manager 1524 is communicably connected to a Hardware Security Module (HSM) interface 1513. The HSM interface 1513 may be a secure configuration terminal (SCT). The connection between the transaction manager 1512 and the HSM interface 1513 is typically a secured line connection. The HSM interface 1513 is connected directly to an HSM 1514. The HSM 1514 or the HSM interface 1513 may include an card reader 1515 for reading data from a key card 1526.

In accordance with embodiments of the invention the preferred embodiment, the Hardware Security Module 1514 is a programmable or intelligent HSM. A programmable HSM is, generally, an HSM that is capable of interpreting injected data as programmatic instructions. Programmatic instructions may refer to executable images like an application written in a programming language such as assembly code, C or C++. Runtime images like a JAVA application may be used as programmatic instructions.

By programming the intelligent HSM 1514, the HSM 1514 may implement programmed behavior either statically or dynamically. In this way, the HSM 1514 may be programmed to securely interact with the cryptography functions of the HSM 1514. Applications may be downloaded into the HSM 1514 using any secure methodology. For example, the applications may be input into the HSM 1514 using a serial port, a network adaptor, smart cards, floppy disks, cd-ROMs, an infrared port or any other known input mechanism. In accordance with the preferred embodiment, a smart card 1526 may be used to inject algorithms, keys or other secure data into the HSM 1514.

The executable code injected into the HSM 1514 is typically authenticated using a digital signature of the executable code generated by an authorized publisher. Other authentication methods may be used. The executable image, when executed, is programmed so that data is exchanged between the HSM 1514, the HSM interface 1513 and other connected systems in a secure manner. In particular, the programming prevents compromise of the HSM 1514 including the algorithms and keys stored therein. The HSM 1514, in accordance with the preferred embodiment, is capable of both reading and writing to smart card 1526.

The HSM 1514 may be a Tamper Resistant Security Module (TRSM), preventing physical as well as logical intrusion. Using approved software components, a customized secure configuration terminal (SCT), ACL definitions, policies and procedures, the programmable HSM 1514 can be made to meet X9 key management requirements. In particular, the HSM 1514 can perform X9 compliant key exchange keys, split knowledge key management, dual control, key fragments, key pair generation, key injection, key combining, key exchange, key loading, key recovery, destruction of keying material, key management with encrypted keys, PIN block creation, PIN block translation, PIN management with encrypted PIN. The HSM 1514 may be an X9 compliant tamper proof enclosure with key destruction when the enclosure of the HSM has been compromised. Policies and procedures for these processes can be audited and are verifiable.

The HSM 1514 may be encased in a durable, tamper-resistant casing to protect the system against intrusion, with built-in detection features capable of sensing sophisticated attempts at physical or electronic tampering. An unauthorized attempt to access the HSM results in the immediate and automatic erasure of the secured algorithms and data stored in the HSM 1514. The HSM 1514 is a TRSM capable of enforcing key confidentiality and separation. The HSM 1514 allows dual control, tamper detection and active countermeasures such as automatic key erasure upon compromise. These types of devices and environmental security measures currently exist in many systems of financial institutions, network processing centers and military installations.

The HSM 1514 may also use access control lists to allow fine-grained control over key separation, key injection and key management. The HSM 1514 will preferably be programmed so that it will only accept authenticated trusted code provided by an authenticated trusted publisher. Authentication of the trusted code and trusted publisher is typically achieved using an appropriate digital signature authentication protocol.

The HSM 1514 may be programmed to refuse to load trusted code during key loading processes. The HSM 1514 may be programmed to restrict code loading in accordance with X9 audit procedures. The HSM 1514 should pass FIPS-140 validation requirements. The HSM 1514, in conjunction with an SCT and approved key management practices allow for the management of keys for injection into devices that are physically or geographically separate, as may be required for business continuance best practices. The HSM 1514, in conjunction with an SCT, can meet or exceed all key management practices required by the X9 TG-3 audit guidelines or associated standards.

To make the HSM 1514 compliant with X9 requirements, the programmed HSM 1514 requires that private keys and symmetric keys exist inn an acceptable secure format. The keys may be rendered as cleartext inside the protected memory of a tamper resistant security module, or encrypted when rendered outside of the protected memory of a tamper resistant security module. The keys may be rendered as two or more key fragments or key components either in cleartext or ciphertext and managed using dual control with split knowledge fragmentation of the keys. Secret-sharing enables the key fragments to be stored separately on tokens so that less than all of the key fragments (k-of-n key fragments) are required to load or reconstitute the key being protected. Good security practice requires key separation, whereby each key or key pair is generated for a particular purpose and used solely for the purpose for which it was intended.

The HSM interface 1513 may be interfaced directly or indirectly with the HSM 1514 for loading the key-encryption-key (KEK), key pairs as well as any other activity necessary to meet X9 standards for key management. Accordingly, the HSM interface 1513 may be connected directly to the HSM 1514, for example using an SCSI, IDE, serial port, parallel port, USB port, keyboard, mouse, or firewire port. The HSM interface 1513 may be connected indirectly to the HSM 1514, for example using an infra-red port. The HSM interface 1513 may be interoperable with the HSM 1514 via use of smart cards with supporting processes and procedures to insure key management policies and procedures can be implemented. Future connection methodologies that comport with the required standards may also be used.

The HSM interface 1513 may be encased inn a durable, tamper-resistant casing to safeguard the system against incursion. The HSM interface 1513 should also include built-in detection techniques capable of sensing sophisticated attempts at physical or electronic tampering. These techniques may provide for immediate and automatic erasure of secured algorithms and data stored in the device.

In accordance with one embodiment, the HSM interface 1513 may provide graphics display, allowing it to support a variety of graphic character sets, including Japanese, Chinese, Arabic and Cyrillic-based languages. The display may be configured to show two lines of Chinese prompts, two lines of large characters or up to four lines of Roman text. The HSM interface 1513 may be capable of displaying two languages simultaneously, such as French and English, for use in multi-lingual environments.

The HSM interface 1513 may be configured to support custom application development and remote downloading of an executable image. The download process will typically require a trusted code source and use an executable code that is authenticated, through a digital certificate, hash, MAC or other methodology sufficient to prove the authenticity and integrity of the executable code.

The HSM interface 1513 may provide access control using smart cards, token devices, passwords or other methodology. Access control is used to insure that code downloads can only be accomplished by authorized trusted entities. Use of the HSM interface 1513 may be restricted using access control. Key loading is restricted to authorized parties using access control. Key injection is restricted to authorized parties using access control. Software download is restricted to proprietary protocols and otherwise restricted using access control.

The HSM interface 1513 insures that access to any keying information entered can not be controlled or denied to one or all users of the HSM 1514. The HSM interface 1513 may provide an interface for the HSM 1514. The HSM interface 1513 may provide simultaneous support for multiple key management functions. The HSM interface 1513 may provide comprehensive software security and tamper-proof casing. The HSM interface 1513 may store keys securely in a security chip. The HSM interface 1513 may include the ability to wipe keys from the security chip upon completion of keying activity if required. The HSM interface 1513 may provide secure communications between a keyboard, a display and a security module. The HSM interface 1513 may provide a PIN pad that supports alpha-numeric entry. The HSM interface 1513 may provide a smart card reader and writer supporting a plurality of asynchronous and synchronous memory and protected-memory cards. The HSM interface 1513 may include a magnetic strip reader that can read and write Track 1 and 2 or Track 2 and 3. The HSM interface 1513 may provide a serial interface.

The HSM interface 1513 smart and magnetic card reader 1515 may provide a secure and verifiable erasure feature to insure no residual keying material exists after keys have been injected or keying material has been discarded. This may be implemented as a procedure that requires erasure of the material be performed and verified to substantive level. The card reader and writer 1115 may support both EMV for smart card support, debit cards, credit cards, and ATM cards.

The HSM interface 1513 may be both physically and electronically secure, and may contain an integral security module, with an encryption chip, that offers simultaneous support for encryption and key management functions. The security module may be provided to work with DES, Triple DES, ECC, AES, RSA encryption, and supports Master/Session Key, DUKPT (derived unique key per transaction) and regional key management methods.

The HSM interface 1513 may provide additional features that are not required to secure the HSM 1514, as the device may include higher order utility capabilities for acting as a PIN pad in online and offline debit transactions.

The HSM interface 1513 is communicably connected, typically by a secure line connection, to a closed network 1518 such as the ATM Network. This closed network 1518 provides communication to one or more financial institutions 1520. Transaction for the transfer of monies from one account to another is performed by communications transmitted through the ATM Network 1518.

In typical prior art systems, using software-based cryptography, all of the cryptographic components (i.e., algorithm, key, cleartext, ciphertext) reside in unprotected memory, where they are susceptible to duplication, modification, or substitution. The most susceptible element is the cryptographic key. A duplicated key allows an attacker to recover all encrypted data. In addition a duplicated asymmetric private key allows an adversary to falsely generate digital signatures that would be attributed to the computer owner. A substituted or modified public key would allow a “man-in-the-middle” attack such that the adversary could intercept and change e-mails or transaction data undetectable by the sender or receiver.

In the hardware-based cryptography, physical and logical barriers limit data access, while the algorithm and key are kept secure in the protected memory of the HSM 1514. Thus, hardware based cryptography ensures the confidentiality, integrity, and authenticity of cryptographic keys and, further, provides assurance regarding the integrity and authenticity of the cryptographic algorithm, which reinforces the overall level of security.

The secure PIN processing system 1500 insures that the key management policies, practices and life cycle controls which deal with an organization's policies and practices regarding the management of private asymmetric keys, symmetric keys, and other types of keying material (e.g., pseudo-random number generator seed values), including cryptographic hardware management. Key management life cycle control information should be disclosed to allow relying parties to assess whether the organization maintains sufficient controls to meet its business requirements and insure key generation practices, such that cryptographic keys are generated in accordance with industry standards.

The secure PIN processing system 1500 manages the random or pseudo-random number generation process, prime number generation, key generation algorithms, hardware and software components. The secure PIN processing system maintains adherence to all relevant standards as well as references to the key generation procedural documentation including key storage and backup. Asymmetric private keys and symmetric keys remain secret and their integrity, authenticity and recovery practices may be retained. The secure PIN processing system 1500 allows the use of key separation mechanisms using hardware and software components. This permits provable adherence to all relevant standards and provides references to key storage, backup, and recovery procedures. The secure PIN processing system 1500 controls the initial key distribution processes, subsequent key replacement processes, and key synchronization mechanisms.

The secure PIN processing system 1500 relies on the HSM 1514 not just for security by also to insure the cryptography, which is CPU intensive, is optimized for high scalability, and is capable for supporting diverse applications. The secure PIN processing system and process 1500 may dramatically increase the number of cryptographic keys generated, distributed, installed, used, and eventually terminated. This proliferation will stress the scalability of key management software and the key storage mechanisms that will be forced to manage more and more cryptographic keys.

With reference to FIG. 16, another exemplary PIN transaction process 1600 is shown. A customer initiates a transaction with a merchant at function block 1602. The merchant connects the customer to a PIN transaction module at function block 1604. The PIN transaction module establishes secure communication with the customer computer at function block 1606. The customer inputs biometric data at function block 1608. The biometric data is authenticated at decision block 1610. If the biometric data does not match the customer identity, the process follows the NO path to end at system block 1612. If the biometric data is authenticated, the process follows the YES path to function block 1614 where the customer inputs associated PIN data. The computer generates an authentication message using the input data and sends the message to the PIN transaction module at function block 1616. The PIN transaction module receives the authentication message at function block 1618. The PIN transaction module provides the authentication message to the security module at function block 1620. The security module generates the PIN and generates an ATM message at function block 1622.

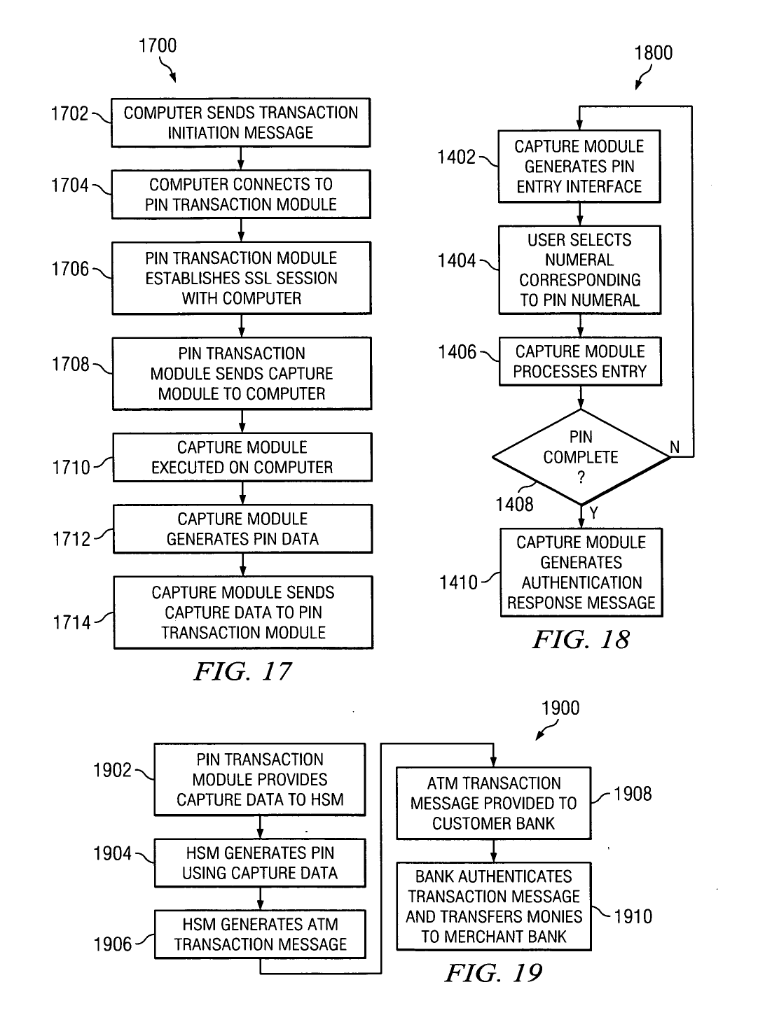

With reference to FIG. 17, yet another exemplary PIN transaction process 1700 is shown. A computer sends a transaction initiation message at function block 1702. The computer is connected to a PIN transaction module at function block 1704. The PIN transaction module establishes an SSL session with the computer at function block 1706. The PIN transaction module sends a capture module to the computer at function block 1708. The capture module is executed on the computer at function block 1710. The capture module generates PIN data with user input at function block 1712. The capture module sends the capture data to the PIN transaction module for processing at function block 1714.

With reference to FIG. 18, an exemplary PIN capture process 1800 is shown. A capture module generates a PIN entry interface on the customer computer at function block 1802. The user selects numerals corresponding to the user's PIN at function block 1804. The capture module process the selected numeral at function block 1806. The process determines if the PIN is complete at decision block 1808. If the PIN is not complete, the process follows the NO path to function block 1802 and collects another numeral. If the PIN is complete, the process follows the YES path and the capture module generates an authentication response message at function block 1810.

With reference to FIG. 19, another exemplary PIN process 1900 is shown. A PIN transaction module provides capture data to a security module at function block 1902. The security module generates a PIN using the capture data at function block 1904. The security module generates an ATM transaction message at function block 1906. The ATM transaction message is provided to the customer bank at function block 1908. The bank authenticates the transaction message and transfers monies accordingly at function block 1910.

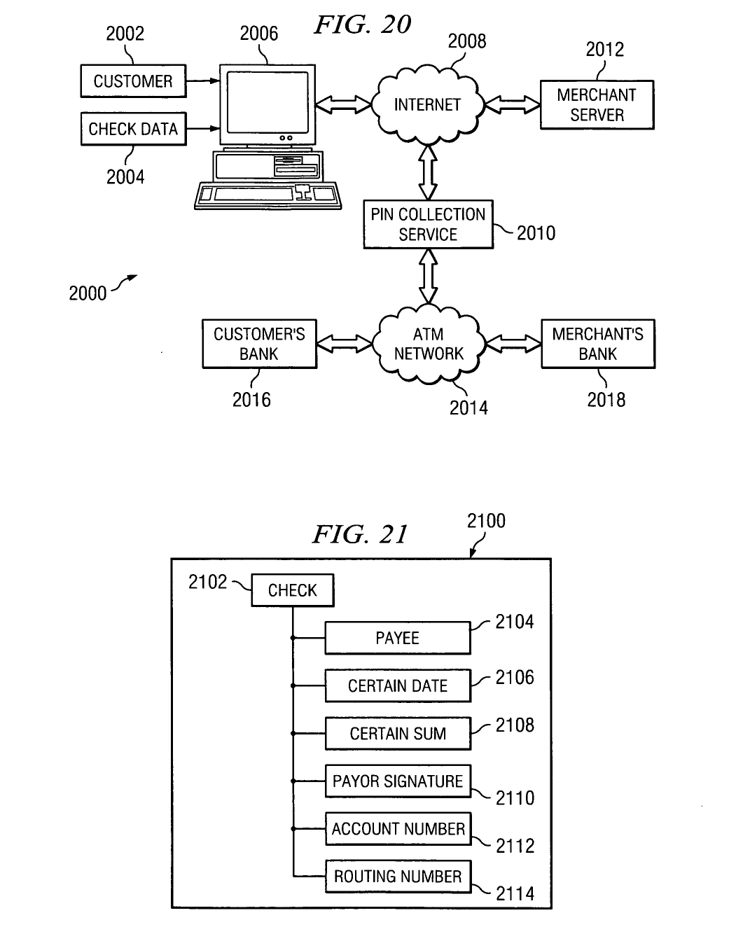

With reference to FIG. 20, an exemplary PIN processing system 2000 is shown. A customer 2002 uses a computer 2006 to enter check data 2004. The computer 2006 is communicably connected to a network 2008. The check data 1604 is sent to a merchant server 2012. The merchant server 2012 connects the customer computer 2006 to a PIN collection service 2010. The PIN collection service securely collects the PIN from the customer 2002. An ATM transaction message is generated using the PIN and sent to the customer's bank 2016 via secure network 2014. The customer's bank 2016 authenticates the PIN. This authentication serves as the customer's signature on the check. The check data including the signature is presented to a bank 2018. The monies are transferred to the merchant's account accordingly.

With reference to FIG. 21, an exemplary diagrammatic representation of a negotiable instrument 2100 is shown. A negotiable instrument 2100 may by represented as an electronic check 2102. The electronic check 2102 may include a payee 2104, a date certain when payment is to be made 2106 and a sum certain 2108 defining the amount of money to be transferred by the instrument 2100. A payor signature 2110 is used to authenticate the instrument 2100. The payor's account number 2112 and the routing number of the payor's bank 2114 are typically necessary to complete the transfer transaction.

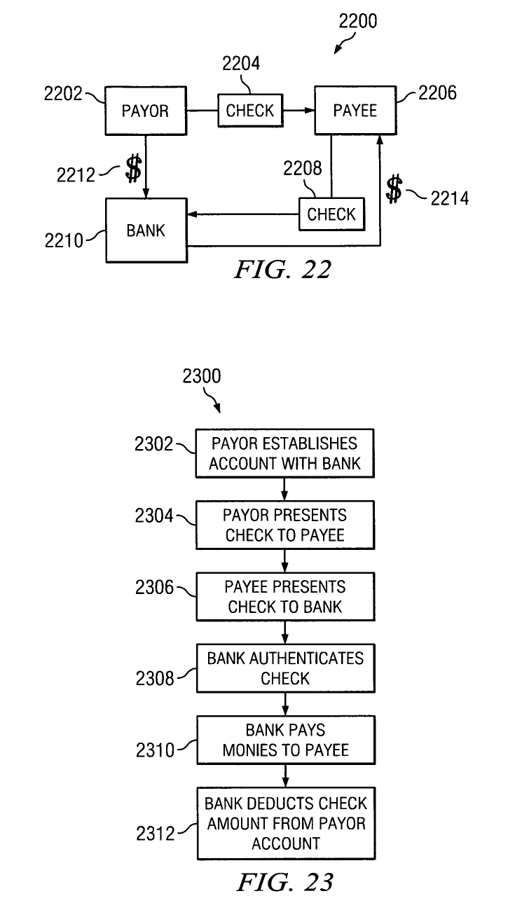

With reference to FIG. 22, an exemplary check payment system 2200 is shown. A payor 2202 deposits monies 2212 at a bank 2210. The payor presents a check 2204 to a payee 2206 for value. The payee accepts the check 1804 and endorses the check 2204 to generated endorsed check 2208. The endorsed check 2208 is presented to a bank 2210. The bank 2210 authenticates the endorsed check 2208 and pays monies 2214 to the payee 2206 accordingly. This check payment system may utilize a Internet

With reference to FIG. 23, an exemplary check process 2300 is shown. A payor establishes an account with a bank and deposits funds in the account at function block 1902. When the payor presents a check to a payee at function block 2304, the payee endorsed the check and presents it to a bank at function block 2306. The bank authenticates the check including the signature and endorsement at function block 2308. The bank pays monies to the payee accordingly at function block 2310. The bank deducts the amount of the paid check from the payor's account at function block 2312.

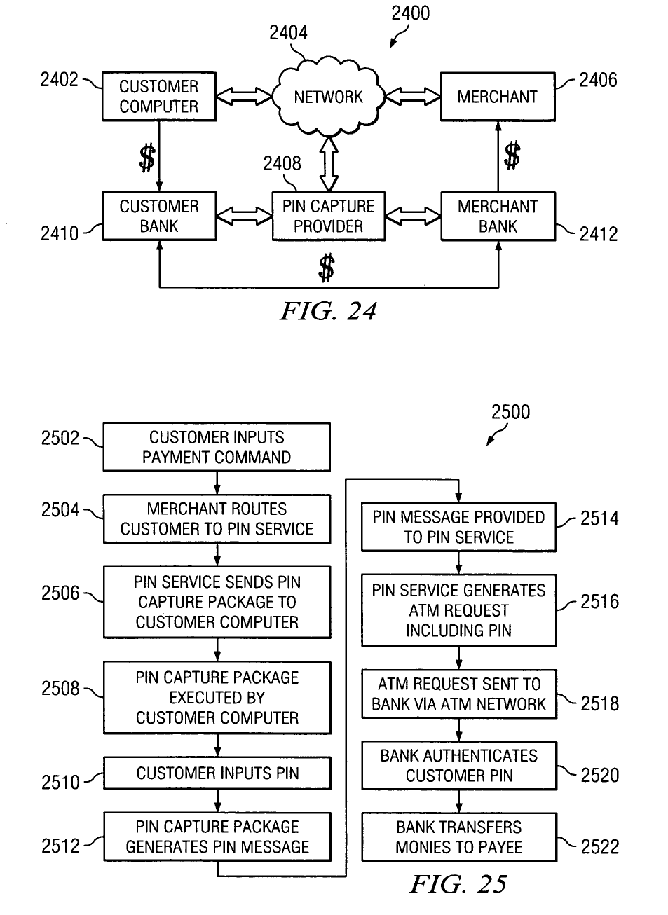

With reference to FIG. 24, an exemplary PIN capture system 2400 is shown. A customer computer 2402 generates a payment command and sends the payment instruction to a merchant 2406 via insecure network 2404. The merchant 2406 connects the customer computer 2402 to a PIN capture provider 2408. The PIN capture provider 2408 securely captures the customer PIN and sends a transfer request to customer bank 2410. The customer bank authenticates the customer and transaction. The customer bank transfers monies accordingly to merchant bank 2412.

With reference to FIG. 25, an exemplary PIN service process 2500 is shown. A customer inputs a payment command at function block 2502. A merchant routes the customer to a PIN service at function block 2504. The PIN service sends a PIN capture package to the customer computer at function block 2506. The PIN capture package is executed by the customer computer at function block 2508. The customer inputs a PIN at function block 2550. The PIN capture package generates a PIN message at function block 2552. The PIN message is provided to the PIN service at function block 2554. The PIN service generates an ATM request including the PIN. The ATM request is sent to a bank using a secure network such as the ATM network at function block 2558. The bank authorizes the customer and the transaction using the PIN at function block 2520. The bank transfers monies to the merchant accordingly at function block 2522.

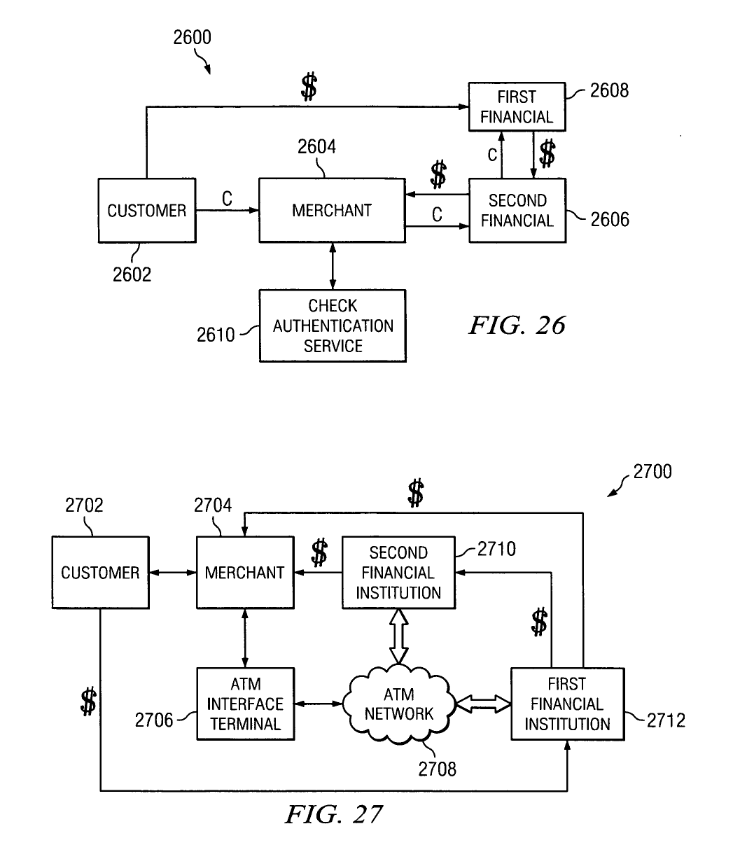

With reference to FIG. 26, an exemplary check authentication system 22600 is shown. A customer 2602 presents a check to a merchant 2604. Merchant 2604 provides check information to a check authentication service 2610. The check authentication service 2612 authenticates the check information and authorizes or denies the transaction. When authorized, the merchant 2604 accepts the check and presents the check to a financial institution 2606. The financial institution 2606 presents the check to the payor's financial institution 2608. The payor's financial institution 2608 authenticates the check and fund availability and transfers finds to the payee's financial institution 2606 accordingly. The payee's financial institution 2606 tenders payment to the merchant 2604.

With reference to FIG. 27, an exemplary on-site ATM merchant transaction system 2700 is shown. A customer 2702 arranges a transaction with a merchant 2704. The merchant 2704 provides transaction information to an ATM interface terminal 2706. The customer 2702 is prompted to input account information and a PIN at the ATM interface terminal 2706. The ATM interface terminal sends a transaction request to a first financial institution 2412 using the ATM network 2706. The first financial institution 2712 authenticates the customer's account information and authorizes the transfer to a second financial institution 2710 with a merchant account.

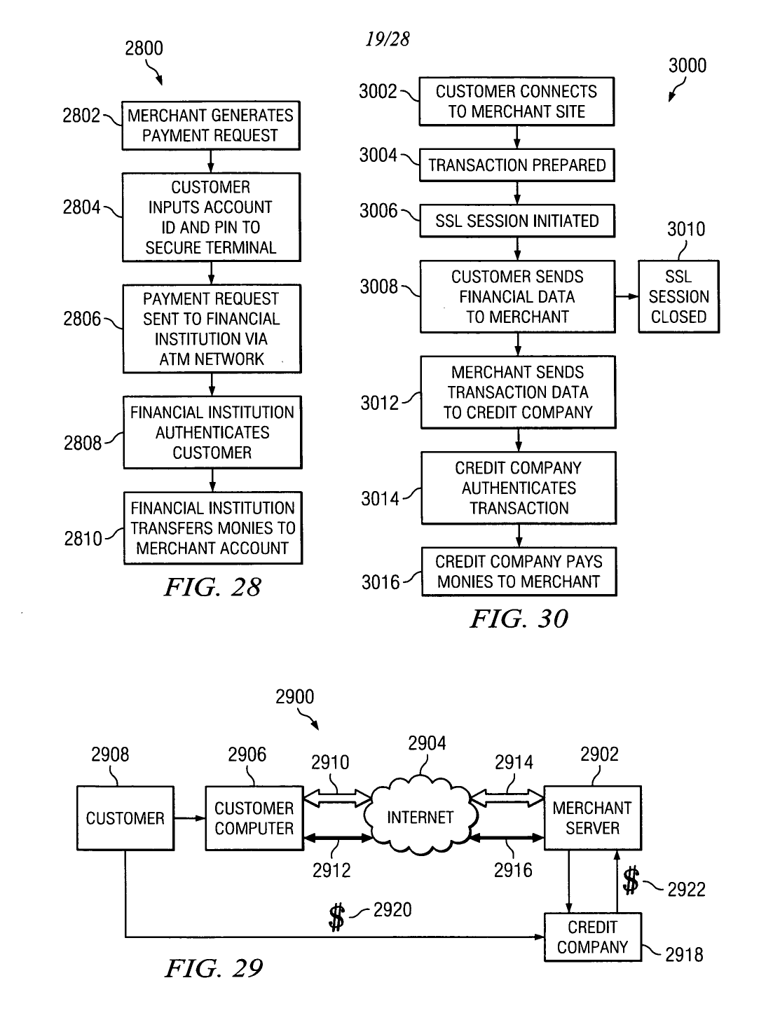

With reference to FIG. 28, an exemplary ATM process 2800 is shown. A merchant generates a payment request at function block 2802. A customer inputs account information and a PIN using a secured ATM terminal at function block 2804. A payment request is sent to a financial institution via the ATM network at function block 2806. The financial institution authenticates the customer and authorizes the transaction at function block 2808. The authorized monies are transferred to the merchant at function block 2810.

With reference to FIG. 29, an Internet credit transaction system 2900 is shown. A customer 2908 using a computer 2906 connects to a merchant server 2602 via the Internet 2904. The initialization process is usually conducted using a non-secure connection 2910 and 2914. When the customer 2908 is prepared to arrange payment, a secure communication session 2912 and 2916 is established between the customer computer 2906 and the merchant server 2902. Credit account information including authentication data is securely communicated to the merchant server 2902. The merchant server 2902 communicates the transaction information to a credit company 2918. The credit company 2918 transfers monies 2922 to the merchant in accordance with the transaction arrangement The credit company collects monies 2920 from the customer 2908 accordingly.

With reference to FIG. 30, an exemplary network transaction process 3000 is shown. A customer connects to a merchant website at function block 3002. A transaction between the customer and the merchant is prepared at function block 3004. An SSL session, or other available protocol session is initiated between the customer computer and the merchant computer at function block 3006. The customer sends financial data to the merchant at function block 3008. The SSL session is closed at function block 3010. The merchant sends the transaction data to a credit company at function block 3012. The credit company authorizes the transaction at function block 3014. The credit company pays monies to the merchant in accordance with the transaction at function block 3016.

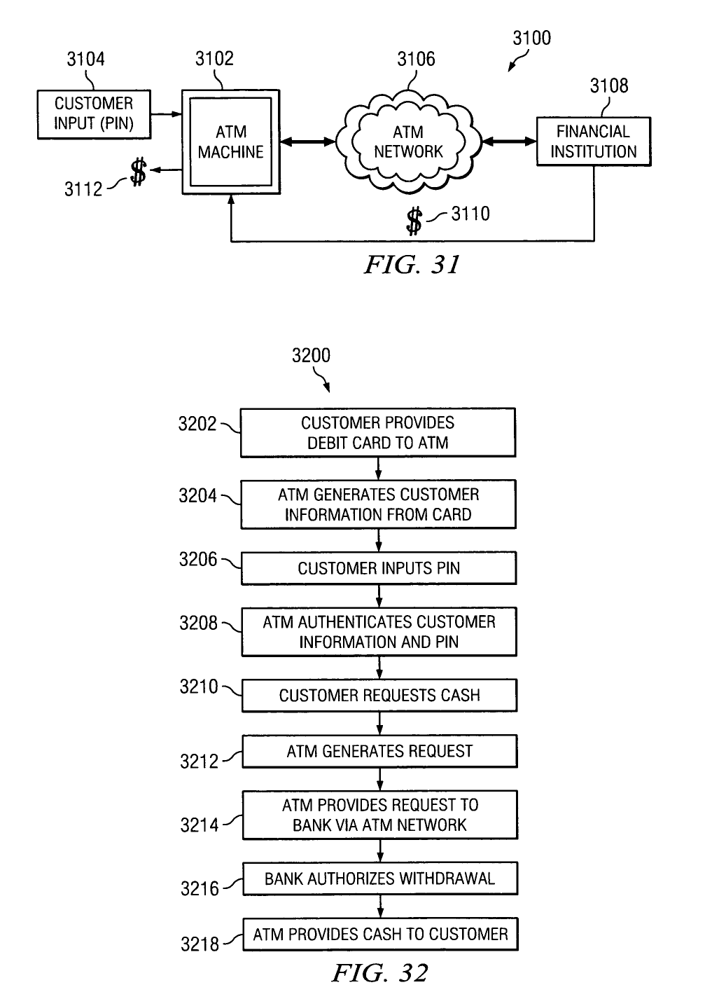

With reference to FIG. 31, an exemplary ATM transaction system 3100 is shown. An ATM terminal 3102 is typically a physically secure, tamper-proof device that is connected to the ATM network 3106. The ATM network 3106 may be a private, secure network. A financial institution 3108 typically places cash 3110 in the ATM terminal. Customer inputs 2804 may include identification information, account information and a customer PIN. When a customer requests a withdrawal of funds from the ATM 3102, the customer typically inputs an account number and PIN 3104. The ATM terminal 3102 prepares an ATM request message including the PIN 3104. The ATM request message is sent to a financial institution 3108 via the ATM network 3106. The financial institution 3108 authenticates the ATM request message. If the request is authenticated using the PIN, the financial institution 3108 sends a transfer approval message to the ATM terminal 3102. Monies 3112 are dispensed by the ATM 3102.

With reference to FIG. 32, an exemplary ATM transaction process 3200 is shown. A customer provides debit card information to an ATM at function block 3202. The ATM generates customer information from the provided information, typically by reading the debit card's magnetic strip or memory at function block 3204. The customer inputs a PIN to a secured key pad at function block 3206. The ATM authenticates the customer using the customer information and the PIN at function block 3208. The customer requests monies at function block 3210. The ATM generates a transaction message at function block 3212. The ATM sends the transaction message to a bank via the ATM network at function block 3214. The bank authenticates the transaction at function block 3216. The ATM provides monies to the customer at function block 3218.

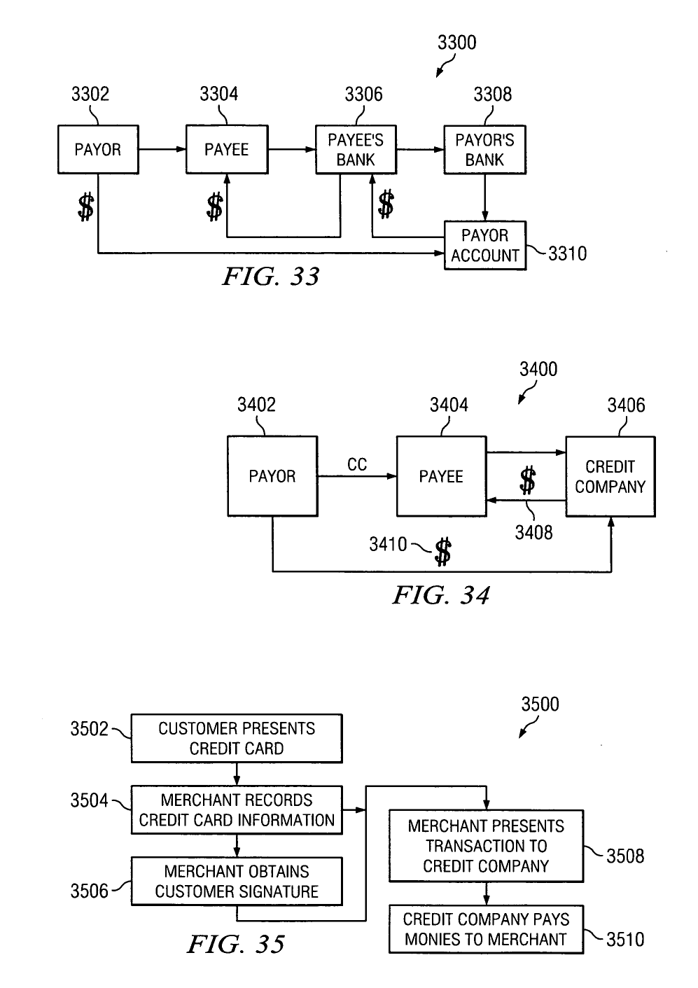

With reference to FIG. 33, an exemplary check processing system 3300 is shown. A payor 3302 deposits monies into a payor account 3010 at a payor's bank. The payor 3302 presents a negotiable instrument to a payee 3304. The payee 3304 typically presents the negotiable instrument to a bank 3306. The payee's bank 3306 typically authenticates the payee endorsement and pays the payee 3004 according to the terms of the negotiable instrument. The payee's bank 3306 presents the endorsed check to the payor's bank 3308. The payor's bank 3308 typically authenticates the payor signature on the negotiable instrument and transfers the finds from the payor's account 3310 to the payee's bank 3306.

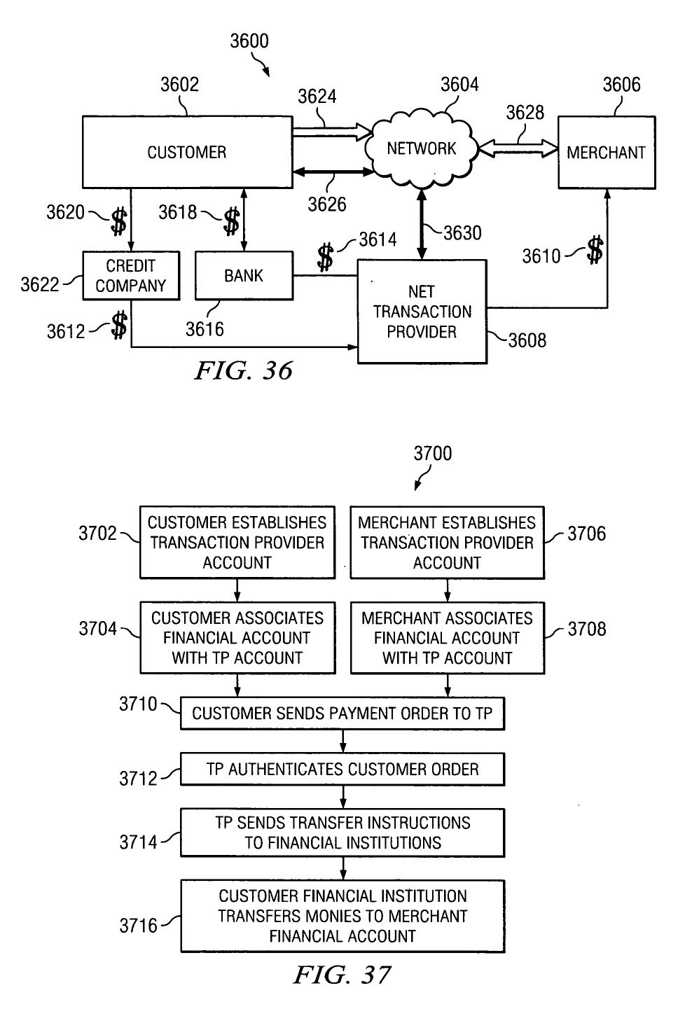

With reference to FIG. 36, an exemplary credit processing system 3400 is shown. A payor 3402 having an account with a credit company 3406 presents a credit card to a payee 3404. The payee 3404 authenticates the credit card. The payee 3404 sends transaction information to credit company 3406. The credit company 3406 transfers monies to the payee 3404 in accordance with the transaction and collects monies from the payor 3402 accordingly.

With reference to FIG. 35, an exemplary a credit transaction process 3500 is shown. A customer presents a credit card to a merchant at function block 3502. The merchant records the credit card information at function block 3504. The merchant may obtain a customer signature to authenticate the transaction at function block 3506. The merchant presents the transaction to the credit company associated with the credit card at function block 3508. The credit company pays monies to the merchant accordingly at function block 3510.

With reference to FIG. 36, an exemplary net transaction processing system 3600 is shown. A customer 3602 connects to a merchant 3606 via network 3604, typically over unsecured communication paths 3624 and 3628. When the customer 3602 is ready to arrange payment, merchant 3606 directs the customer 3602 to a net transaction provider 3408. A secure communication session 3626 and 3630 is established between the customer 3602 and the net transaction provider 3608. The customer 3602 typically arranges payment with the net transaction provider 3608 via a financial institution such as a credit company 3422 or a bank 3616. The net transaction provider 3608 presents the transaction to the bank 3616 or credit company 3622 and receives payment 3614 or 3612. Money is transferred to the merchant 3610 in accordance with the transaction. The customer 3602 deposits finds 3618 into the bank 3616 or pays 3620 the credit company 3622 accordingly.

With reference to FIG. 37, an exemplary transaction provider process 3700 is shown. A customer establishes an account with a transaction provider at function block 3702. The customer typically associates a financial account with the transaction provider account at function block 3504. A merchant also establishes an account with the transaction provider at function block 3706. The merchant associates a financial account with the transaction provider account at function block 3708. When the customer arranges a payment to the merchant, a payment order is sent to the transaction provider at function block 3710. The transaction provider authenticates the customer and the transaction at function block 3712. The transaction provider sends transfer instructions to the customer's financial institution at function block 3714. The customer's financial institution transfers monies from the customer account to the merchant's account at the merchant's financial institution at function block 3716.

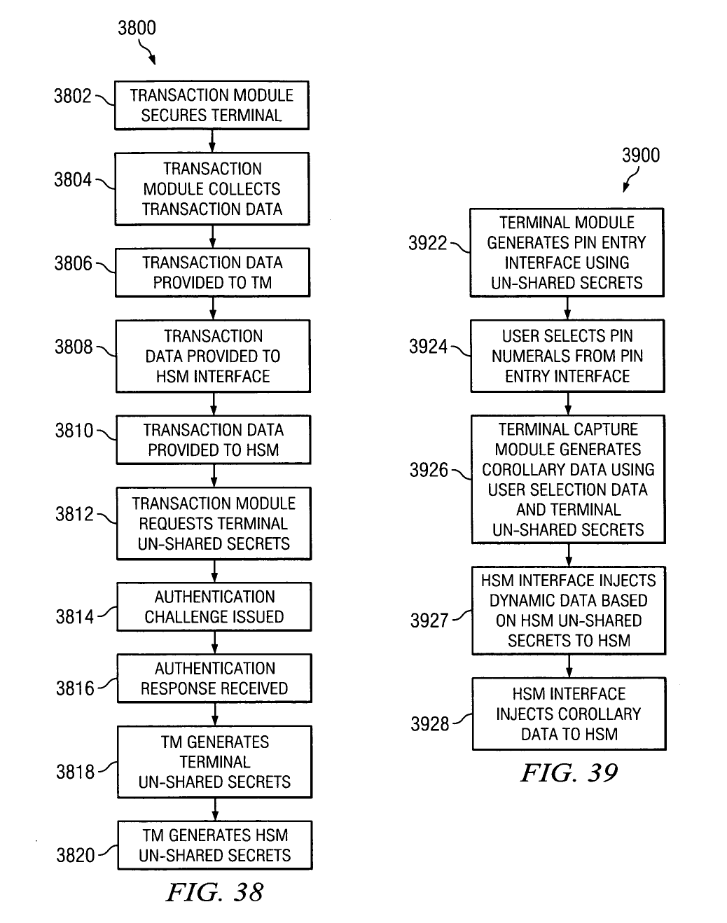

With reference to FIG. 38, an exemplary transaction process 3800 is shown. When the transaction module is executed, the transaction module performs a procedure for securing the customer terminal in step 3802. The process for securing the customer terminal may include checking the location, registry, behavior cryptographic, and memory of the customer terminal. The transaction module checks to see if there is any indication that the transaction process may be rendered insecure by the customer, customer software or customer hardware. A port scan is performed. The customer terminal interrupts and vectors are checked. The transaction module searches for hardware errors, anomalies, or unusual set-ups. The goal is to insure that the customer terminal is a generic computer running generic software. If the transaction module determines that the customer terminal is for any reason insecure, the transaction process is terminated.

When the customer terminal is determined to be secure, the transaction module sends transaction data to the transaction manager in step 3804. Some or all of the transaction data may be sent by the transaction manager to the HSM interface in step 3806. Some or all of the transaction data may also be sent by the HSM interface to the HSM at function block 3808. The specific transaction data shared by the transaction module, transaction manager, HSM interface and the HSM depends on the particulars of the protocols underway.

The transaction module requests terminal unshared secrets from the transaction manager in step 3812. Typically, the transaction manager sends an authentication challenge to the transaction module in step 3814. An authentication response is sent by the transaction module to the transaction manager in step 3816. The interchange of authenticating data may be performed in a variety of ways. The authentication may be bi-directional, such that the transaction module is authenticated to the transaction manager and the transaction manager is authenticated to the transaction module. The authentication may take place at other times during the process, and may be repeated in some protocols. Because the identity of the participants are especially important in a financial transaction, a wide variety of authentication protocols and procedures may be implemented to accomplish that goal. The transaction manager generates terminal unshared secrets in step 3818. Then, the transaction manager generates HSM unshared secrets 3820.

With reference to FIG. 39, an exemplary transaction process 3900 is shown. The transaction manager generated HSM unshared secrets in step 3820 of FIG. 38. The terminal unshared secrets are used to allow the transaction module to properly form and encode corollary data used to identify the PIN of the customer. The HSM unshared secrets are used by the HSM to convert the corollary data into the customer PIN. The unshared secrets may include algorithms, portions of algorithms, families of algorithms, identifiers for selecting algorithms, portions of algorithms or families of algorithms. The unshared secrets may include data to modify the algorithms. Variables may be established by the unshared secrets.

The transaction manager sends the terminal unshared secrets to the transaction module and sends the HSM unshared secrets to the HSM. The transaction module generates a graphical PIN input interface for display on the customer terminal 3904 using the unshared terminal secrets in step 3922. The customer selects displayed portions of the graphical PIN input interface using a mouse, touch screen, or other curser movement user interface to generate cursor location data in step 3924. The graphical PIN input interface includes a graphical display of a numeric keypad, such the customer selects a digit of the PIN by clicking a mouse button when the mouse cursor is over the appropriate numeral. With each entered digit, the displayed keypad may be scrambled, such that a given mouse cursor location may indicate a different numeral with each entered digit. The cursor location data for each digit of the PIN is used by the transaction module to generate corollary data using the selection and the unshared terminal secrets in step 3926. The corollary data is sent to the transaction manager which further sends the corollary data to the HSM interface. The HSM interface injects the corollary data into the HSM in step 3928.

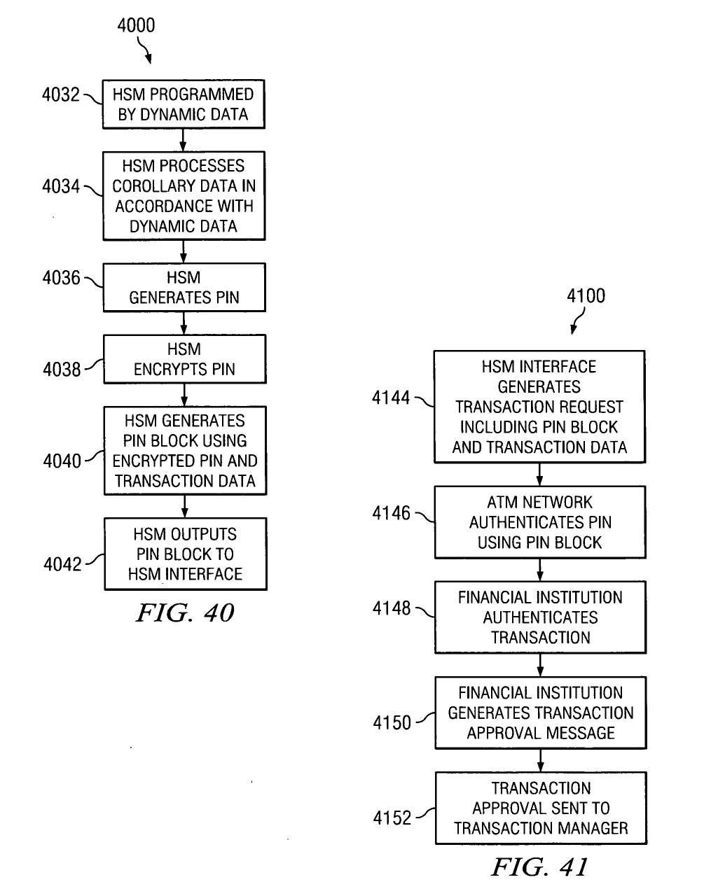

With reference to FIG. 40, an exemplary transaction process 4000 is shown. The HSM interface injects dynamic data including the unshared HSM secrets into the HSM at function block 4032. The HSM processes the corollary data in accordance with the dynamic data at function block 4034. The HSM calculates the customer PIN in step 4036.

The HSM encrypts the PIN in step 4038. The HSM generates a PIN block using the encrypted PIN and transaction data at function block 4040. The HSM sends the PIN block to the HSM interface in step 4042.

With reference to FIG. 41, an exemplary transaction process 4100 is shown. The HSM interface generates a transaction request including the PIN block at function block 4144 and sends the transaction request to the ATM Network. The ATM Network or the financial institution authenticates the PIN at function block 4146. The financial institution authenticates the transaction in step 4148. The financial institution 4120 then generates a transaction approval message at function block 4150 and sends the transaction approval message to the transaction manager at function block 4152. The transaction manager typically may notify the merchant server that the transaction has been processed.

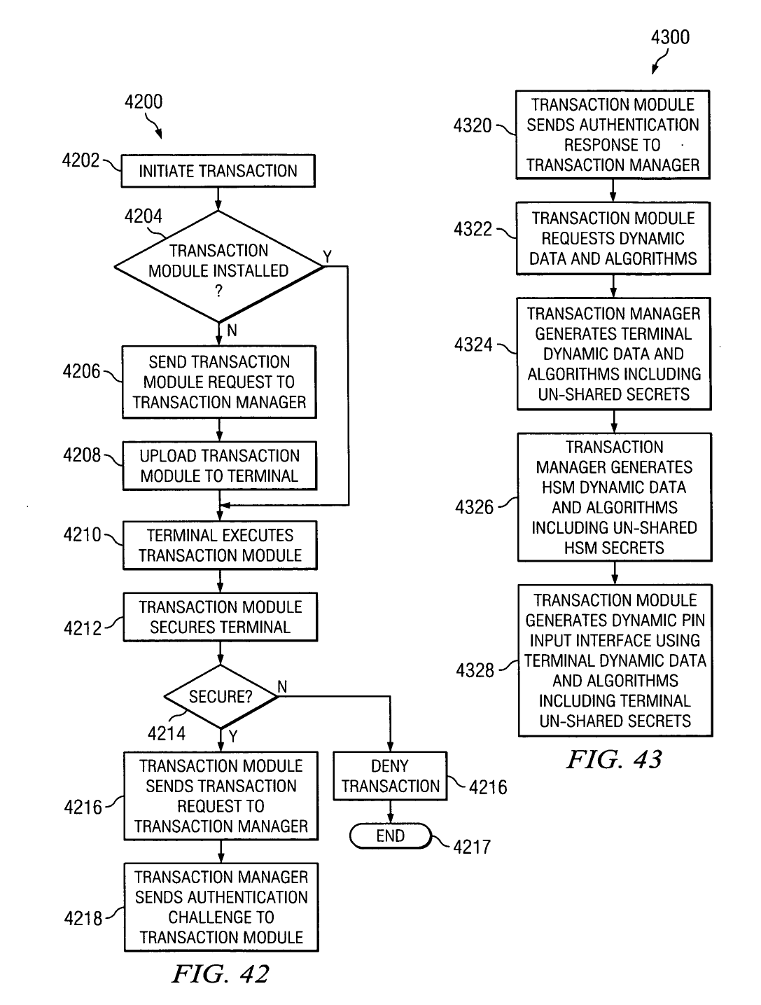

With reference to FIG. 42, an exemplary secure PIN collection process 4200 is shown. The process begins as the transaction is initiated in function block 4202. A check is done to determine if the transaction module has been installed at the customer terminal at decision block 4204. If a traction module has not been installed, the process follows the NO path to function block 4206, sending a transaction module request to the transaction manager. The transaction manager retrieves the transaction module file from the transaction manager database and uploads the transaction module to the customer terminal at function block 4208 and proceeds to function block 4210.

If the transaction module was previously installed, the process follows the YES path to function block 4210. At function block 4210, the customer terminal executes the transaction module. The transaction module then secures the customer terminal at function block 4212. A check is made to determine if the customer terminal is secure at decision block 4214. If the customer terminal is not secure, the process follows the NO path to function block 4216 where the transaction is refused. The process then ends at block 4217.

If the customer terminal is determined to be secure, the process follows the YES path to function block 4216. The transaction module sends a transaction request to the transaction manager at function block 4216. The transaction manager sends an authentication challenge to the transaction module at function block 4218.

With reference to FIG. 43, an exemplary PIN collection process 4300 is shown. The transaction module sends an authentication response to the transaction manager at function block 4320. If the authentication is not verified, the transaction is refused. The transaction module requests dynamic data and algorithms at function block 4322. The transaction manager generates terminal dynamic data and algorithms including unshared terminal secrets at function block 4324.

The transaction manager generates HSM dynamic data and algorithms (DYDA) including unshared HSM secrets at function block 4326. The transaction module generates a dynamic PIN input interface using terminal dynamic data and algorithms including unshared terminal secrets at function block 4328.

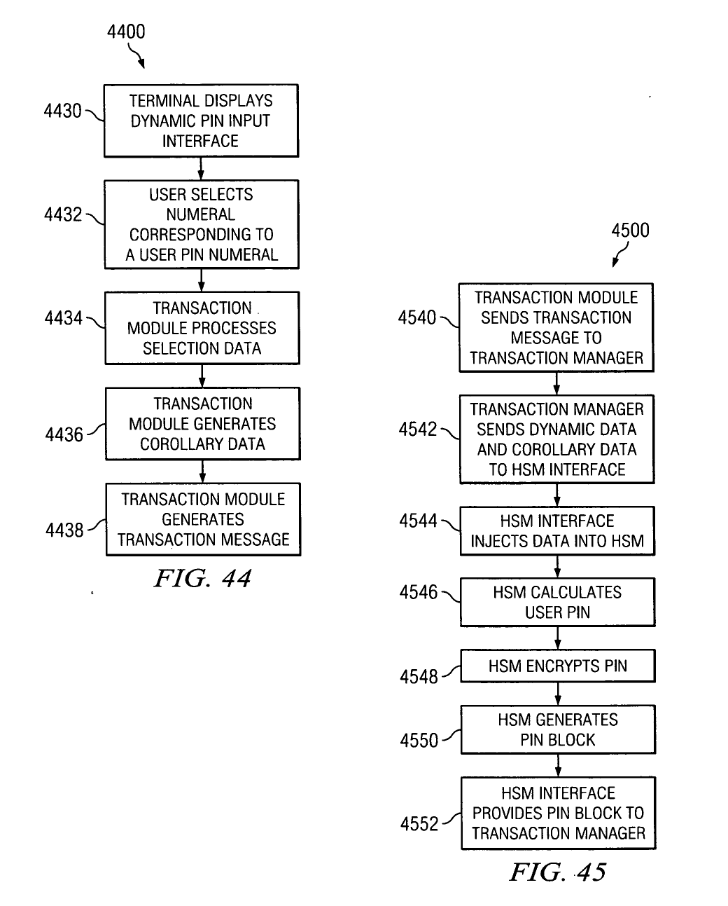

With reference to FIG. 44, an exemplary PIN collection process 4400 is shown. The customer terminal displays the dynamic PIN input interface at function block 4430. The user clicks the mouse button in correspondence to the location of a cursor over displayed digits in the dynamic PIN input interface in function block 4432. The transaction module records the cursor location data at function block 4434. The transaction module generates corollary data using the dynamic data and algorithms and the cursor location data at function block 4436. The transaction module generates a transaction message including transaction data and corollary data at function block 4438.

With reference to FIG. 45, an exemplary PIN collection process 4500 is shown. Proceeding to function block 4540, the transaction module send the transaction message to the transaction manager. The transaction manager sends the dynamic data and algorithms and the corollary data to the HSM interface at function block 4542. The HSM interface injects the HSM dynamic data and algorithms, seed data and corollary data to the HSM at function block 4544. Proceeding to function block 4346, the HSM calculates the customer PIN, based on the algorithms, seed data and corollary data. The HSM encrypts the PIN using an injected key-encryption-key at function block 4548. The HSM may encrypt the PIN using any of a variety of encryption techniques. The encryption may be performed using a dual-controlled, split-knowledge key, which has been injected into the HSM using a smart card. The HSM then generates a PIN block using the encrypted PIN at function block 4550. The HSM interface sends the generated PIN block to the transaction manager at function block 4552.

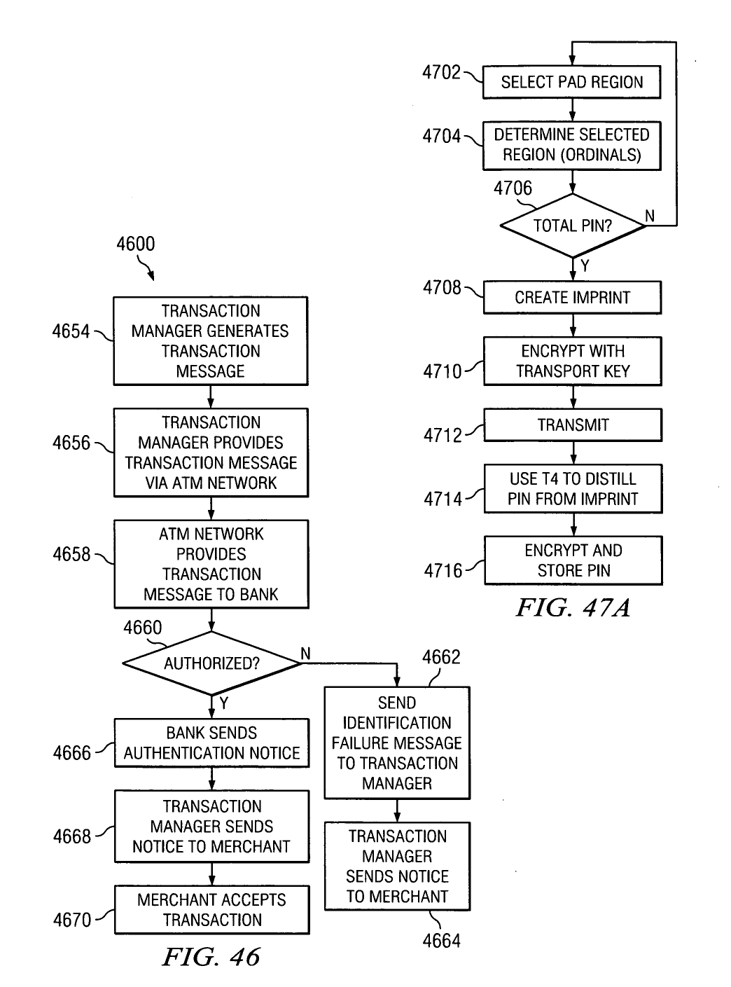

With reference to FIG. 46, an exemplary transaction process 4600 is shown. The transaction manager generates a transaction message using the transaction data and the PIN block at function block 4654. The transaction manager then sends the transaction message to the ATM Network at function block 4656. The ATM Network sends an authorization request to the Financial Institution at function block 4658.

At decision block 4660, the financial institution determines if the transaction is authorized. If the transaction is not authorized, the process follows the NO path to function block 4662 where financial institution may send a “transaction denied” message to the transaction manager. The transaction manager may send a “transaction denied” message to the merchant server at function block 4664.

If the transaction is authorized, the process follows the YES path to function block 4666. The financial institution sends a “transaction approved” message to the transaction manager at function block 4666. The transaction manager sends a “transaction approved” message to the merchant server. The financial institution debits the customer's account in accordance with the transaction data at function block 4470.

It will be recognized by those skilled in the art that the protocols for transferring monies from a payor to a payee may be configured in a variety of ways. The use of ATM authentication to provide a signature for an electronic check can be implemented in numerous ways, of which the described embodiment is only one. In particular, the interactions with the financial institutions and the methods of providing the monies to the payee may be performed in a variety of financially suitable ways.

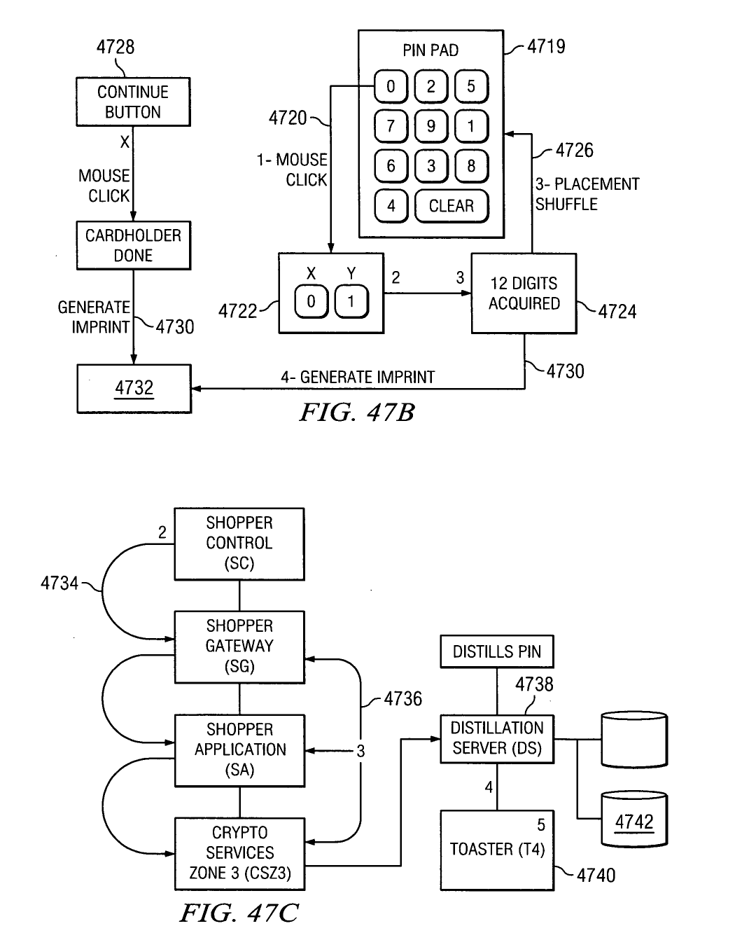

Referring now to FIG. 4 and FIG. 47A, there is illustrated a flow diagram describing the manner in which an imprint or impression of the PIN is generated and transmitted between a transaction module 105 and an authentication authority 121. This imprint and transmission procedure provides a method where the acquisition of data by a graphical interface or mouse enables data to be selected and a nonspecific imprint created of the data that may be transmitted over an outside secure line. The data may comprise for example a PIN, a nonspecific imprint does not in and of itself provide the selected data entered by user. Thus, if the nonspecific imprint were to be intercepted by an unauthorized party the user selected data would not be discernable to the unauthorized party. The nonspecific imprint may then be received at the authentication manager 121 and the data selected by the user extracted from the nonspecific imprint such that this data may be injected or stored with secure data without exposing the user selected data to the outside world.

Initially the user selects a pad region on the user interface at step 4742. Within the transaction module 105A the selected region is then determined. At such that the ordinals the region selected may be established at 4704. Inquiry step 4706 determines if the complete data entry has been received. In this example, a PIN number is used such that a determination is made if the total number of numerals for the PIN have been selected. If not, control passes back to 4702 where in a next pad region is selected. Once all of the data has been selected, an imprint of this data may then be created at 4708. The imprint comprises a nonspecific graphical representation of the data selected by the user. The imprint is encrypted with a transport key at 4702 and its been transmitted step 4712 from the transaction module 105 to the authentication manager 121. A “T4” security module is used to distill the user selected data from the imprint at 4714. The distilled user data is encrypted and stored at 4716 within the security module such that the user data is not excisable to the external world.

Referring now to FIG. 47B, there is more fully illustrated the process for generating the imprint discussed with respect to FIG. 47A. Initially the user selects a pad region of a graphical interface that collates to a region occupied by the pin pad using for example, a mouse click at 4720. The sauce application evaluates wether this selected region is valid. If the selected region is valid, the coordinates are retained, referred to as an ordinal value at 4722. The ordinal value comprises an XY value that is associated with a particular location on the pin pad 4719. The client evaluates wether 12 sets of ordinals have been established, and if not the client requests that the sauce application generates another unique placement shuffle of the components on the pin pad 4719. This process occurs at 4724 and 4726. Once it is determined at 4724 that 12 ordinals are acquired, or when a card holder elects to press the continue button at 4728, an imprint is generated at 4730. The creation of the imprint involves the ordinals and the numbers of hits being assembled in a 128 bit block pads. The pads will be placed into a pre-allocated message block called the imprint data 4732.

Referring now to FIG. 47C, there is more fully illustrated, the process for transmitting imprinted data. Once the shopper control has generated a digital imprint from consumer mouse clicks as described in FIG. 47B, the shopper encrypts the digital imprint at 4734 with the imprint transport key. Next, at 4736, the shopper sends the encrypted imprint to the distillation server 4738. The distillation server uses T4 to distill the PIN from the digital imprint and T4 converts the PIN into PIN PAN at 4740. The PIN block is encrypted and placed within the data store 4742, and the pin block is automatically deleted from the data store 4742 three business days after its generation. In embodiments where a PIN is not used, the distillation server extracts a user credential(s) from the digital imprint to preserve the integrity of the credential itself form accidental exposure because the credential may represent private or non-public data.

Embodiments of the present invention enable transactions over non-secure network when the user presents any one of these user credentials: (a) PIN, (b) Debit Card and PIN, (c) biometric, (d) biometric and PIN, (e) biometric and Debit Card and PIN, (f) PIN and search code (e.g. account number, phone number, drivers license), (g) search code, or (h) biometric and search code. In other words, a transaction over a non-secure network can be performed using any permutation, mutation or combination of a PIN, DEBIT Card (ATM card, credit card, gift card, ECT.), biometric, or search code.

When authentication of a consumer has been completed over the non-secure network, the underlying financial or non-financial transaction can be considered non-reputable and said authentication is recognized under one or more of the invention embodiments as an electronic signature and in compliance with e-sign law. Furthermore, subsequent transactions, performed by the consumer as part of the same or related transactions (e.g. a payment transaction), may retain the all of benefits afforded in the authentication transaction.

Furthermore, the user credentials can be used to authenticate the consumer's identity and enable them to perform various financial and non-financial transactions. Also the user credentials can be used to authenticate ACH information provided by third parties (e.g. merchants and other financial institutions or service providers), or to securely obtain ACH information (e.g. routing numbers, account numbers, available and reserve balance amounts).

Embodiments of the invention also use user credentials to authenticate and authorize transactions:

To obtain verification of the users account and balance information;

To transact ACH, perform wire transfers from one DDA to another party's account;

To authorize deductions or deposits for the users DDA by a 3^{rd} party;

To authorize contract obligations, financial and non-financial (e.g. recurring payments and subscription contracts);

To authorize access to a wallet or other data store or 3^{rd} party service that may possess identity, private or other data about the consumer to another party or to the consumer himself;

To access online accounts and systems (e.g. online banking, registration enrollment services); and

To authorize use and access for payment to a wallet or other payment service.

It will be appreciated by those skilled in the art having the benefit of this disclosure that this invention provides a secure authentication system and method. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. Method of authenticating a consumer and authorizing a transaction over a network, the method comprising:
requesting, by a user, performance of a transaction between said user and a merchant, said user and the merchant performing the transaction over a non-secure web page;
entering, by said user, transaction request information into a non-secure general purpose computer;
entering a user credential, by said user, into a user interface of the non-secure web page on the non-secure general purpose computer;
providing, by said non-secure general purpose computer, said transaction request information and a user credential data package, said user credential data package being a digital representation of an impression or imprint of said user's selection of at least one graphic image representing a user's bonafide user credential to a secure transaction manager via an Internet system;
combining, by said transaction manager, at least one of dynamic and corollary data with said user credential data package and securely providing the combination to a hardware security module (HSM);
distilling, by said HSM, said user credential data package into the user' bonafide credential and encrypting said user's bonafide credential into a PIN Block; and
performing the remainder of said transaction.

2. The method of claim 1, wherein said user credential comprises data from a debit card or an ATM card.

3. The method of claim 1, wherein said user credential comprises data from a biometric device or process.

4. The method of claim 1, wherein the remainder of said transaction comprises:
authentication, by an ATM network, a biometric network, or a financial institution, of said user credential.

5. The method of claim 2, wherein said transaction information comprises an account number for said debit card or said ATM card.

6. The method of claim 5, wherein said transaction information further comprises at least one of said account number's available funds, funds held on reserve.

7. The method of claim 3, wherein said transaction information further comprises a wallet, said wallet includes at least one of payor information, said consumer's identity information, medical information, financial information.

8. The method of claim 7, wherein said consumer's identity information comprises at least one of a driver's license number, social security number, a passport number, and a date of birth.

9. The method of claim 1, wherein said user credential comprises at least one of (a) a PIN, (b) a Debit Card and said PIN, (c) a biometric, (d) said biometric and said PIN, (e) said biometric, said Debit Card, and said PIN, (f) said PIN and a search code, (g) said search code, and (h) said biometric and said search code.

10. The method of claim 7, wherein said financial information comprises at least one of a DDA, a debit card, a credit card, a gift card, SWIFT information, a Fed-wire information, a wire information, a trading account, a brokerage account.

11. The method of claim 7, wherein said medical information comprises at least one of a health provider information, medical history information, and a medical record release authorization.

12. The method of claim 1, wherein the remainder of the transaction comprises authentication and authorization by an ACH for the transfer of a user's funds from a DDA to anther party.

13. Method of authenticating a consumer and authorizing a transaction over a network, the method comprising:
requesting, by a user, performance of a transaction between said user and a merchant, said user and the merchant performing the transaction over a non-secure web page;
entering, by said user, transaction request information into a non-secure general purpose computer;
entering a user credential, by said user, into a user interface of the non-secure web page on the non-secure general purpose computer;
providing, by said non-secure general purpose computer, said transaction request information and a user credential data package, said user credential data package being a digital representation of an impression or imprint of said user's selection of at least one graphic image representing a user's bonafide user credential to a secure transaction manager via an Internet system;
combining, by said transaction manager, at least one of dynamic and corollary data with said user credential data package and securely providing the combination to a hardware security module (HSM);
extracting, by said transaction manager, said user credential data package into the user' bonafide credential; and
performing the remainder of said transaction.

14. The method of claim 13, wherein said step of extracting is further preformed by said HSM.
